(19) United States
(12) Patent Application Publication
(10) Pub. No.: US 2016/0358456 A1
(43) Pub. Date: Dec. 8, 2016

(54) METHOD AND DEVICE FOR DEPLOYING A LINK BETWEEN AT LEAST ONE SECURITY SYSTEM AND AN ALARM CENTER

(71) Applicant: FINSECUR, Nanterre (FR)

(72) Inventors: LAURENT PICHARD, NANTERRE (FR); STÉPHANE DI MARCO, NANTERRE (FR); MATHIEU VERNEUIL, NANTERRE (FR)

(21) Appl. No.: 15/035,823

(22) PCT Filed: Nov. 14, 2014
(86) PCT No.: PCT/FR2014/052910

§ 371 Date: Jul. 15, 2016

(30) Foreign Application Priority Data
Nov. 14, 2013 (FR) 1361141
Nov. 14, 2013 (FR) 1361145
Nov. 15, 2013 (FR) 1361233
Dec. 23, 2013 (FR) 1363502

(51) Int. Cl. G08B 25/10; G08B 25/00; A62C 37/50; H04W 4/00

(52) U.S. Cl. CPC G08B 25/10; H04W 4/008; G08B 25/003; A62C 37/50

(57) ABSTRACT

A method for deploying a link between at least one security system and an alarm control unit. Each security system is fixed in position. A mobile terminal, having a frequency-spreading key and a short-range wireless signal transmitter having a transmission range less than or equal to the communication range of a wireless local network, is positioned close to a fixed security system. The frequency-spreading key is transmitted to the fixed security system via short-range wireless signals. The alarm control unit is fixed in position at a distance from at least one security system that is greater than the transmission distance of the short-range wireless signal transmitter. A security message is communicated between a communication channel of at least one security system and the alarm control unit, implementing spectrum spreading depending on the spreading key.

### TECHNICAL FIELD OF THE INVENTION

The present invention relates to a method and a device for deploying a link between at least one security system and an alarm control unit. It applies, in particular, to the protection against risks at sites such as, for example, dwellings or industrial or business sites.

### STATE OF THE ART

For the rest of the document, the term “supercapacitor” will refer to a capacitor whose power density and energy density fall between batteries and conventional electrolytic capacitors.

The term “site” refers to an area comprising at least one premises corresponding, for example, to a room.

Protecting a site against dangers, such as fires, currently uses systems comprising:
sensors capturing a physical magnitude whose value can represent the danger, such as the temperature, for example;
a control unit receiving the values transmitted by the sensors, detecting an anomaly in a physical magnitude captured by a sensor; and,
possibly, actuators, such as pistons opening hatches allowing smoke to be evacuated, for example, activated under the control of the control unit when an anomaly is detected.

In some current systems, each sensor and each actuator is connected to the control unit in a wired way. In other current systems, these sensors and actuators are connected wirelessly to the control unit. The disadvantage of current wireless technology is that the wireless transmission between a sensor or actuator and a control unit is fragile in the light of the distances that can separate the control unit and the sensor or actuator. In addition, the electromagnetic noise surrounding a site protected in this way may be a source of transmission faults between a sensor or actuator and the control unit. For these reasons, these systems are either used in smaller rooms or comprise a plurality of control units, making it possible to limit these transmission problems, or repeaters that relay the transmitted signals, which increases maintenance costs and the risks of failure.

In these wireless systems, pairing the control unit and the sensor or actuator is done by pressing on a button of the control unit and on a button of the sensor or actuator. When the button of the sensor or actuator is pressed, this sensor or actuator sends a pairing signal. When the button of the control unit is also pressed, or has been pressed in a period of time less than a predefined limit value, the pairing of the sensor or actuator and the control unit is realized.

In these systems, each actuator or sensor paired in this way close to a control unit is then positioned in the site to be protected. In the most modern systems, each sensor or actuator comprises an identifier representative of the intended location of the sensor or actuator. These systems mean that, when an anomaly is detected, the area where the anomaly occurred can be spatially identified. These systems facilitate the intervention of emergency services when the site protected is large. The problem with these systems is that a human error in positioning can occur between the pairing and the installation of the sensor or actuator. This problem can lead to serious consequences when an area is incorrectly indicated as the location of the incident. Similarly, maintenance operations are complicated by these errors.

In addition, in accordance with the standards in force, the operation of each portion of such systems must be tested once a year. In current systems, these tests must be performed manually.

For all these reasons, current wireless systems for protecting a site do not make it possible to provide an optimum response to the requirements for:
reliability of the wireless transmission;
reliability of the actual location information of a sensor or actuator.

In particular, document WO2005/119609 is known, which stipulates a wireless communication implementing frequency spectrum spreading of the communication. However, this document does not in particular resolve the problem of the reliability of a sensor's location information. Secondly, this document does not stipulate a solution to the problem of an error in positioning a sensor/detector/actuator by a system operator.

In particular, document EP2204787 is known, which stipulates a wireless communication between devices. This document does not resolve the problem of the reliability of the communication between devices, and the document's technical stipulations does not allow a site protection system to be deployed on a large site without having to multiply the relays and alarm control units.

In certain systems for protecting an area against fires, smoke vents are positioned high up in the area to allow the smoke contained in this room to be evacuated during a fire. The opening of these vents is controlled by an alarm control unit after this control unit has detected a fire in the area protected by these systems.

These systems have several drawbacks.

Firstly, because of standards imposing rapid opening of the vents, actuators causing each vent of the device to be opened require significant amperage, of the order of one ampere. When several devices are present, the total amperage demanded requires installing cables with substantial cross-sections. In order to remedy this disadvantage, some systems comprise an electrical cabinet connected by cables to each vent of the device. However, these electrical cabinets use a lot of space and the cables used impose a considerable constraint on the installation of the system due to the dimensions of these cables.

Secondly, maintenance standards for these systems require each vent to undergo maintenance once a year. This maintenance includes, in particular, opening and closing the vent to verify the proper operation of this vent. In current systems, these tests are performed manually, which does not make it possible to reliably establish that, for each portion of the system, the length of time between two tests complies with regulatory obligations.

In some current systems, vents are connected wirelessly to the control unit. The disadvantage of current wireless technology is that the wireless transmission between a vent and a control unit is fragile, given the distances that can separate the control unit from the vent. In addition, the surrounding electromagnetic noise may be a source of transmission faults between a vent and the control unit. For these reasons, these systems are either used in smaller rooms or comprise a plurality of control units, making it possible to limit these transmission problems, or repeaters that relay the transmitted signals, which increases maintenance costs and the risks of equipment failure. In addition, these current systems have one-way downward communication from the alarm control unit, which prevents the alarm control unit obtaining any information whatsoever from the vent.

In accordance with the standards in force, the operation of each portion of such systems must be verified once a year. In current systems, these tests are performed manually, which does not make it possible to reliably establish that, for each portion of the system, the length of time between two tests complies with regulatory obligations. Secondly, the opening panels can be difficult to access since they are positioned high up, for example.

In addition, in some current systems the opening of an opening panel is controlled by the alarm control unit when a fire is detected. However, for certain fires, it is preferable to limit the amount of oxygen present in the room where the fire has occurred.

For all these reasons, current wireless systems for protecting a site do not make it possible to provide an optimum response to the requirement for reliability of the normative length of time between two operating tests for the device.

With regard more specifically to the winches opening hatches to the outside of a room, it is not currently possible to detect:
whether the winch must be opened according to environmental conditions in the room;
the winch's working order; or
the absence of maintenance operations specified by regulations.

In addition, in current systems, if several extinguishers each comprising a different extinguishing agent are close to each other, a user can pick the wrong extinguisher to fight a specific type of fire. For example, a “D powder” extinguisher, ie mainly composed of sodium chloride or sodium carbonate and calcium phosphate, must be used on metal fires. Conversely, foam extinguishers cannot be used, because of the foam's conductivity, on electrical fires, and it is even dangerous to use them on these fires.

For all these reasons, current wireless systems for protecting a site do not make it possible to provide an optimum response to the requirement for reliability of the normative length of time between two operating tests for the device. In addition, current wireless systems do not allow a user to identify whether an extinguisher must or must not be used to fight a specific type of fire.

With regard more specifically to the extinguishers, it is not currently possible to detect:
the start of a leakage of the extinguisher product or the partial use of this product;
the removal of the extinguisher from its mount; or
the absence of maintenance operations specified by regulations.

In particular, documents WO2013/007901, WO2013/007902 and US2008/053667 are known, which stipulate extinguisher systems communicating by means of wireless signals. However, none of these documents resolves the problem of reliability of communication or the problem of reliability of the extinguisher's positioning.

### Subject of the Invention

The present invention aims to remedy all or part of these drawbacks.

To this end, according to a first aspect the present invention relates to a method for deploying a link between at least one security system and an alarm control unit, which comprises:
a step of fixing each security system in position;
iteratively:
   a step of bringing a mobile pairing means, retaining a frequency-spreading key and comprising a short-range wireless signal transmission means, having a transmission range less than or equal to the communication range of a wireless local network, close to a fixed security system and
   a step of transmitting the frequency-spreading key to the security system via short-range wireless signals;
a step of fixing the alarm control unit in position at a distance from at least one security system that is greater than the transmission distance of the short-range wireless signal transmission means and
a step of communicating a security message between a communication means of at least one security system and the alarm control unit, implementing spectrum spreading depending on the spreading key.

Thanks to these provisions, each security system is first positioned before being linked to the alarm control unit, which prevents the risks of the incorrect positioning of the system device with respect to a piece of information recorded in the alarm control unit. Secondly, using spread-spectrum communication allows a large site to be covered without having to utilize signal repeaters. In addition, spread-spectrum communication introduces the need for a frequency-spreading key to be transferred prior to communication between alarm control unit and security systems. The short-range transmission means allows this transfer to be realized.

In some embodiments, the alarm control unit, comprising the pairing means, is brought close to each fixed security system during the step of bringing it closer. These embodiments make it possible to reduce the need for intermediate devices likely to be lost once the network's initial link has been set up. Secondly, limiting the number of devices utilized means the device's manufacturing costs can be reduced.

In some embodiments, the method that is the subject of the present invention comprises, iteratively downstream from the transmission step, a step of recording a piece of data representative of the location of the security system, at least one communication between said security system and the alarm control unit comprising a piece of data representative of the location of the security system.

The advantage of these embodiments is that they make it possible to ensure reliability between the piece of data representative of the recorded location and the actual location of the security system.

In some embodiments, the method that is the subject of the present invention comprises a step of supplying an alarm signal and a piece of location information for at least one security system, this signal being emitted when a piece of data received by the alarm control unit is representative of a risk.

These embodiments have the advantage of warning people inside the site of a near-by risk. Secondly, an operator responsible for dealing with the risk, such as the fire service for example, can have precise knowledge of the area of the risk detected.

In some embodiments, the short-range wireless signals have a transmission range less than or equal to the transmission range of a personal network.

The advantage of these embodiments is that they make it possible to increase the reliability of the accuracy of the link between a desired security system and the alarm control unit, the risk of confusion between security systems being reduced with the communication range of the transmission means.

In some embodiments, the short-range wireless signals are transmitted using the Bluetooth standard.

These embodiments utilize technology widely used in the market.

In some embodiments, the frequency-spreading key is transmitted via a signal emitted depending on a frequency of the spread-spectrum wireless signal.

The advantage of these embodiments is to advantageously use the various spread-spectrum frequencies to transmit the spreading key on one of these frequencies and, therefore, to only require one wireless transmission standard for implementation.

In some embodiments, the method that is the subject of the present invention comprises, iteratively downstream from the step of bringing closer:
a step of detecting a pairing signal as a function of a strength of a signal received according to an operating frequency of the communications means higher than a limit value, and
a step of the spreading key being received by the communication means when a pairing signal is detected.

These embodiments enable the security system to detect a pairing signal when the strength of this signal is, for example, higher than the ambient electromagnetic noise.

According to a second aspect, the present invention envisages a device for deploying a link between at least one security system and an alarm control unit for implementing the method for deploying a link that is the subject of the present invention, which comprises:
a means for fixing each security system;
a mobile pairing means, retaining a frequency-spreading key and comprising a short-range wireless signal transmission means, having a communication range less than or equal to the communication range of a wireless local network, for transmitting the frequency-spreading key to the security system via short-range wireless signals;
a means for fixing the alarm control unit at a distance from at least one security system that is greater than the transmission distance of the short-range wireless signal transmission means; and
a means for communicating a security message between at least one security system and the alarm control unit, implementing spectrum spreading depending on the spreading key.

In some embodiments, the security system is a sensor, capturing a value representative of a physical magnitude of the sensor environment, communicating a piece of data representative of the value captured.

In some embodiments, the captured value is representative of the presence of smoke near the sensor.

In some embodiments, the captured value is representative of the presence of flames near the sensor.

In some embodiments, the captured value is representative of the presence of gas near the sensor.

In some embodiments, the captured value is representative of the presence of people near the sensor.

In some embodiments, the security system is an extinguisher mount communicating a piece of data representative of a filling level of an extinguisher fixed to the mount.

In some embodiments, the security system is an extinguisher communicating a piece of data representative of the presence of an extinguisher fixed to the mount.

In some embodiments, the security system is a winch, for opening an opening panel in a room, communicating a piece of data representative of the position of the opening panel.

In some embodiments, the security system is an actuator, for opening an opening panel in a room, communicating a piece of data representative of the position of the opening panel.

In some embodiments, the security system is a defibrillator mount communicating a piece of data representative of the presence of a defibrillator fixed to the mount.

In some embodiments, the security system is a liquid leakage detector communicating a piece of data representative of detection of a leakage of liquid.

In some embodiments, the security system is a sensor, capturing a value representative of a physical magnitude of the internal condition of the sensor, communicating a piece of data representative of the value captured.

In some embodiments, the security system is an extinguisher communicating a piece of data representative of a filling level of the extinguisher.

In some embodiments, the security system is a defibrillator communicating a piece of data representative of a power charge level of the defibrillator.

In some embodiments, the security system is a push-button communicating a piece of data representative of a state of the push-button.

In some embodiments, the security system is an automatic sprinkler system communicating a piece of data representative of a working condition of the sprinkler.

In some embodiments, the security system is a carbon dioxide distribution means communicating a piece of data representative of a working condition of the distribution means.

In some embodiments, the security system comprises an autonomous power supply, and the security system communicates a piece of data representative of a charge level of the power supply.

In some embodiments, the security system comprises a means for emitting an audible and/or visible signal, and the security system communicates a piece of data representative of a state of the means for emitting an audible and/or visible signal.

As the aims, advantages and features of the device that is the subject of the present invention are similar to those of the method for deploying a link that is the subject of the present invention, they are not repeated here.

According to a third aspect, the present invention envisages a protection device for a site implementing a method for deploying a link that is the subject of the present invention, which comprises:
a mount, configured to be fixed to a wall, that comprises a removable fastener for a portable communicating alarm control unit;
at least one fixed sensor of a value representative of a physical magnitude, that comprises a spread-spectrum wireless transmission means configured to emit at least one piece of data representative of the value captured or to receive a wireless signal;
the portable communicating alarm control unit, which comprises:
   a spread-spectrum wireless transmission means for communicating with at least one sensor;
   a means for short-range wireless pairing, utilizing the wireless transmission means, the portable communicating alarm control unit with at least one sensor; and
   a detector configured to transmit a piece of data representative of the detection of an anomaly if at least one value captured is greater than a predefined limit value.

Using a spread-spectrum wireless transmission makes it possible to significantly limit the impact of the electromagnetic noise on the reliability of the transmission. In addition, the mobility of the alarm control unit allows each sensor to be fixed before pairing. In this way, the precise location of each sensor can be identified, and the risk of human error in fixing a sensor in the wrong place, before pairing, is eliminated.

In some embodiments, the portable communicating alarm control unit comprises:
a means for selecting a signal emitted by a sensor, the selection means selecting the emitted signal having the strongest reception by the alarm control unit; and
a means for triggering the pairing means to pair the alarm control unit with the sensor whose emitted signal is selected.

These embodiments have the advantage of making it possible to choose a sensor to be paired with the alarm control unit if a plurality of sensors is close to the alarm control unit.

In some embodiments:
at least one sensor comprises a means for pairing with a portable communicating alarm control unit, configured to make a wireless emission of a pairing request signal until said sensor is paired;
the pairing means of the portable communicating alarm control unit comprises a means for measuring the reception strength of the pairing request signal emitted by the pairing means of a sensor, configured such that pairing the portable communicating alarm control unit and said sensor is performed when the reception strength of the emitted signal is greater than a predefined limit value.

The advantage of these embodiments is that they enable automatic pairing of the alarm control unit and a sensor, provided the signal emitted by this sensor is above the predefined limit value.

In some embodiments:
the selection means selects one received signal, emitted by the pairing means of a sensor, for which the reception strength is strongest, and one received signal, emitted by the pairing means of another sensor, for which the reception strength is the second strongest;
the means for measuring the signal strength of a signal performs a comparison between the two reception strengths of the selected signals; and
the pairing means pairs the portable communicating alarm control unit with the sensor emitting the signal having the greatest strength if said comparison is greater than a predefined limit value.

These embodiments make it possible to improve the reliability of the identification of a sensor to be paired with the portable alarm control unit by comparing the strength of the signals received from a plurality of sensors.

In some embodiments, the portable communicating alarm control unit comprises:
a means for recording the reception strength of a signal emitted by a sensor during a predefined length of time; and
a means for displaying the reception strength recorded.

The advantage of these embodiments is that they make it possible, for a user moving the portable alarm control unit, to identify a sensor, which the user approaches by viewing the change in the reception strength.

In some embodiments, the portable communicating alarm control unit comprises:
a means for entering at least one piece of information; and
a control means for commanding the storing of each piece of information entered at a sensor, said sensor being configured to emit each piece of information stored in association with at least one emitted wireless signal.

These embodiments make it possible to increase the amount of information transmitted by a sensor, such information enabling, for example, the location of a sensor to be identified.

In some embodiments:
the portable communicating alarm control unit comprises a means for detecting at least one identifier representative of another protected site emitted by at least one sensor of said protected site; and
the storage control means is configured to command the storing of an identifier representative of the site to be protected, different from each identifier representative of another protected site detected.

The advantage of these embodiments is that they make it possible to distinguish between signals received from the protected site and those coming from another protected site.

In some embodiments, at least one element amongst at least one sensor and/or the portable communicating alarm control unit comprises a means for verifying the working condition of each said element and a means for transmitting a piece of data representative of this working condition.

These embodiments have the advantage of making it possible to automatically identify an element of the device requiring a maintenance operation. In some embodiments, the portable communicating alarm control unit comprises:
a means for storing a path passing through at least one sensor; and
a means for displaying the stored path.

The advantage of these embodiments is that they make it possible to facilitate, for a user moving the portable alarm control unit from sensor to sensor, the identification of the path to reach these sensors.

In some embodiments, the mount comprises a means for locking the fastener and a power supply means for a battery of the portable communicating alarm control unit.

These embodiments make it possible to both avoid the encumbrance of a wired power supply and to limit the possibilities of the portable alarm control unit being stolen when it is fixed to the wall.

According to a fourth aspect, the present invention envisages a method for protecting a site implementing a method for deploying a link that is the subject of the present invention, which comprises:
a step of fixing a mount to a wall, the mount comprising a removable fastener for a portable communicating alarm control unit;
a step of wireless transmission, by a portable communicating alarm control unit, for communicating with at least one sensor;
a step of short-range wireless pairing the portable communicating alarm control unit and at least one sensor;
at least one step of a fixed sensor capturing a value representative of a physical magnitude, that comprises a step of spread-spectrum wireless transmission during which at least one piece of data representative of the value captured is emitted or a wireless signal is received; and
a detection step during which a piece of data representative of the detection of an anomaly is transmitted if at least one value captured is greater than a predefined limit value.

As the particular features, advantages and aims of the protection method that is the subject of the present invention are similar to those of the site protection device that is the subject of the present invention, they are not repeated here.

In some embodiments, the method that is the subject of the present invention comprises, upstream from the pairing step, a step of fixing at least one sensor to a wall of the site.

These embodiments have the advantage of making it possible to avoid human errors in positioning a sensor after this sensor is paired with the portable alarm control unit.

In some embodiments, the method that is the subject of the present invention comprises a step of storing a path passing through at least one sensor and a step of displaying the stored path.

The advantage of these embodiments is that they make it possible to facilitate, for a user moving the portable alarm control unit from sensor to sensor, the identification of the path to reach these sensors.

According to a fifth aspect, the present invention envisages a device for ventilating a room implementing a method for deploying a link that is the subject of the present invention, which comprises:
an actuator configured to open an opening panel of the room;
a means for pairing with an alarm control unit;
a means for controlling the actuator, configured to control the opening or closing of the opening panel according to a received signal;
a means for communicating wirelessly with the alarm control unit configured to receive a smoke evacuation signal;
a means for storing electrical energy, charged by an electrical power supply source, configured to power the actuator during the opening of the opening panel after a smoke evacuation signal has been received.

Thanks to these provisions, when a smoke evacuation signal is received by the communication means, the actuator is activated so as to open the room. In order to power this actuator, the energy storage means discharges the electrical energy stored during the charging of this storage means by the electrical power supply source. In this way, it is possible to use conventional electrical cables not imposing space constraints when implementing the device in a room. Similarly, this device does not require an electrical cabinet to be used, which reduces the device's installation costs and the space required for this installation.

In some embodiments:
the communication means is configured to receive a ventilation signal;
the actuator control means is configured to command the opening of the opening panel according to the ventilation signal received; and
the power supply source is configured to power the actuator during the opening of the opening panel.

These embodiments have the advantage of making it possible, depending on the signal received, for the actuator to be powered by the storage means on receipt of a smoke evacuation signal representative of the detection of a fire by the alarm control unit. It is also possible for the actuator to be powered by the power supply source during an opening of the opening panel in response to a ventilation signal.

In some embodiments, the ventilation signal comprises a piece of information representative of a degree of opening for the opening panel, the control means being configured to command a degree of opening of the opening panel as a function of the piece of information representative of a degree of opening of the opening panel.

The advantage of these embodiments is that they make it possible to regulate the degree of opening of the opening panel according to an opening degree determined by a user and transmitted in the ventilation signal.

In some embodiments, the communication means is a means for spread-spectrum wireless communication with the alarm control unit.

These embodiments have the advantage of enabling robust communication with regard to a degree of electromagnetic noise between the alarm control unit and the communication means.

In some embodiments, the device that is the subject of the present invention comprises:
a sensor of a value representative of a physical magnitude;
a detector configured to determine a piece of information relative to the opening panel as a function of the captured value, the communication means being configured to transmit a signal representative of the piece of information detected to the alarm control unit.

The advantage of these embodiments is that they make it possible, for example, to transmit to the alarm control unit a piece of information representative of whether the opening panel is open or not.

In some embodiments, the detector is configured to determine a piece of information representative of the degree of opening of the opening panel as a function of the captured value.

These embodiments have the advantage of enabling more precise information to be transmitted to the alarm control unit.

In some embodiments:
the actuator comprises a rotary motor;
the sensor is a rev counter for the motor; and
the detector detects a degree of opening of the opening panel according to the number of motor revolutions counted.

The advantage of these embodiments is that they enable the opening degree of the opening panel to be detected accurately.

In some embodiments, the motor is a brushless motor and the sensor is a Hall Effect sensor.

These embodiments have the advantage of enabling the opening degree of the opening panel to be detected accurately.

In some embodiments, the device that is the subject of the present invention comprises a means for measuring a length of time since a change to a physical magnitude captured by the sensor, the communication means being configured to emit a warning signal when the length of time measured is longer than a predefined limit time.

The advantage of these embodiments is that they make it possible to identify the need for carrying out maintenance of the device when, for example, the opening panel was last opened more than one year ago.

In some embodiments, the energy storage means is a supercapacitor.

These embodiments have the advantage of enabling the rapid return, compared to a battery, of the energy stored in the supercapacitor.

In some embodiments, the device that is the subject of the present invention comprises:
a sensor of a value representative of a physical magnitude of the device's environment;
a fire detector configured to detect a fire as a function of the value captured; the communication means being configured to send the alarm control unit a signal representative of the detection of a fire.

The advantage of these embodiments is that they allow a reduction in the costs of a fire detection system comprising the device that is the subject of the present invention by combining the device, a sensor and a fire detector.

In some embodiments, the device that is the subject of the present invention comprises:
a means for verifying the working condition of the communication means as a function of a signal received, from the alarm control unit, by the communication means after the verification means has commanded the communication means to emit a standard piece of information to the alarm control unit; and
a means for activating a visual and/or audible alarm as a function of the signal received.

These embodiments enable a user to identify a communication fault between the alarm control unit and the device according to the visual and/or audible alarm.

In some embodiments, the device comprises a means for verifying the working condition of a sensor, configured to command the communication means to emit a piece of information representative of the working condition of the sensor.

The advantage of these embodiments is that they make it possible, for example, to transmit to the alarm control unit a signal representative of an operating fault of a sensor.

According to a sixth aspect, the present invention envisages a protection device for a site implementing a method for deploying a link that is the subject of the present invention, which comprises:
at least one room ventilation device that is the subject of the present invention;
an alarm control unit paired with each room ventilation device, configured to transmit a smoke evacuation signal when a fire is detected;
a ventilation control unit configured to transmit a ventilation signal to at least one ventilation device;
a common power supply source powering each ventilation device.

As the aims, advantages and features of the site protection device that is the subject of the present invention are similar to those of the room ventilation device that is the subject of the present invention, they are not repeated here.

According to a seventh aspect, the present invention envisages a method for ventilating a site by a plurality of ventilation devices that are the subjects of the present invention, each equipped with an opening actuator for an opening panel, which comprises:
a step of charging, in each ventilation device, an energy storage means associated to said ventilation device, by powering the electrical energy storage means with an electrical power supply source common to the ventilation devices;
a step of each device waiting for an ‘open’ or close′ control signal for the opening panels, received from either an alarm control unit or from a ventilation control unit;
if an ‘open’ or ‘close’ control signal for the opening panels is received from the ventilation control unit, a step of successively opening or closing opening panels, powering the actuators by the power supply common to the ventilation devices, the amperage output by the common power supply being less than the sum of the amperages necessary to simultaneously power the actuators; and
if an ‘open’ control signal for the opening panels is received from the alarm control unit, a step of simultaneously opening the opening panels, powering the actuator of each device with the energy storage means associated to said device.

As the aims, advantages and features of the site ventilation method that is the subject of the present invention are similar to those of the site ventilation device that is the subject of the present invention, they are not repeated here.

According to an eighth aspect, the present invention envisages a device for extracting smoke from a room implementing a method for deploying a link that is the subject of the present invention, which comprises:
a winch configured to open an opening panel closing an opening of the room;
a means for pairing with an alarm control unit;
a sensor of a value representative of a physical magnitude;
a detector configured to determine a piece of information representative of the state of the opening panel as a function of the captured value,
a means for spread-spectrum wireless communication with the alarm control unit configured to emit at least one piece of information representative of the opening panel state detected and to receive a wireless signal; and
a means for controlling the winch, configured to command the opening or closing of the opening panel according to a received signal.

Thanks to these provisions, the device that is the subject of the present invention can communicate a signal representative of the working condition of the winch to an alarm control unit. In addition, using a spread-spectrum wireless communication makes it possible to considerably reduce the impact of the electromagnetic noise on the quality of the communication between the device and the alarm control unit. This reduced noise impact makes it possible, in particular, to position the device farther from the alarm control unit than the current wireless systems.

In some embodiments:
the sensor is a rev counter for the motor of the winch; and
the detector is configured to detect the position of the opening panel as a function of the number of revolutions counted.

These embodiments have the advantage of making it possible to detect the position of the opening panel according to the number of revolutions made by the motor of the winch. Determining the position of the opening panel makes it possible, in particular, to measure that a dimension of an opening realized by the winch conforms to an expected dimension.

In some embodiments:
the communication means is configured to receive a command to verify the working condition of the winch;
the winch control means commands the opening and then the closing of the opening panel on receiving the maintenance command; and
the communication means is configured to emit a signal representative of the working condition of the winch as a function of the number of revolutions of the motor captured during the opening and closing of the opening panel.

The advantage of these embodiments is that they make it possible to verify the winch's ability to open and close the opening panel.

In some embodiments:
an additional sensor of a value representative of a physical magnitude;
a fire detection means configured to detect a fire as a function of the captured additional value and a predefined limit value,
   the communication means being configured to emit a piece of information representative of the detection of a fire when the fire detection means detects a fire.

These embodiments allow the device to perform an additional fire detection function making it possible to reduce the installation costs of a site protection device by reducing the requirement for fire sensors.

In some embodiments, the communication means is configured to emit a piece of information representative of the detection of a fire when the fire detection means detects a fire.

The advantage of these embodiments is that they allow the device to communicate the detection of a fire to the control unit so that the control unit can initiate the protection of the entire site comprising the device.

In some embodiments, the control means is configured to command the opening of the opening panel if the detection means detects a fire.

These embodiments make it possible, when a fire is detected, to protect the room by allowing the fire's smoke to escape from the room via the opening closed by the opening panel.

In some embodiments, the means for detecting a fire comprises a means for determining environmental conditions as a function of the captured additional value, the control means being configured to command the opening of the opening panel as a function of the environmental conditions determined.

The advantage of these embodiments is that they make it possible, for example when the environmental conditions require the opening panel not to be opened, not to open the opening panel so as to not fuel the fire.

In some embodiments, the device that is the subject of the present invention comprises a ventilation means configured to blow or exhaust the air inside the room according to the environmental conditions detected.

These embodiments have the advantage of making it possible to facilitate the extinguishing the fire according to the environmental conditions.

In some embodiments, the device that is the subject of the present invention comprises a means for measuring a length of time since a change to a physical magnitude captured by the sensor, the communication means being configured to emit a warning signal when the length of time measured is longer than a predefined limit time.

These embodiments have the advantage of enabling a piece of information to be determined as a function of a variation in a captured value.

In some embodiments, the device that is the subject of the present invention comprises a means for measuring the variation in the physical magnitude captured by the sensor over a predefined limit time, the communication means being configured to emit a warning signal when the variation measured is longer than a predefined limit time.

The advantage of these embodiments is that they make it possible to determine whether a maintenance operation has been carried out on the device since a predefined limit time.

In some embodiments, the device that is the subject of the present invention comprises:
a means for verifying the working condition of the communication means as a function of a signal received, from the alarm control unit, by the communication means after the verification means has commanded the communication means to emit a standard piece of information to the alarm control unit; and
a means for activating a visual and/or audible alarm as a function of the signal received.

These embodiments have the advantage of enabling users to be notified of the malfunction of the communication means by means of an audible and/or visible signal.

In some embodiments, the verification means is configured to perform a verification when a length of time since the reception of a last signal emitted by the alarm control unit is longer than a predefined limit time.

The advantage of these embodiments is that they make it possible to verify the state of the pairing between the device and the alarm control unit.

In some embodiments, the device that is the subject of the present invention comprises a means for verifying the working condition of the sensor, configured to command the communication means to emit a piece of information representative of the working condition of the sensor.

These embodiments have the advantage of enabling a piece of information relative to the working condition of the sensor to be communicated to users by means of the alarm control unit.

According to a ninth aspect, the present invention envisages a protection device for a site implementing a method for deploying a link that is the subject of the present invention, which comprises:
at least one room smoke extraction device that is the subject of the present invention; and
an alarm control unit configured to be paired with at least one smoke extraction device.

As the aims, advantages and features of the protection device that is the subject of the ninth aspect of the present invention are similar to those of the device that is the subject of the seventh aspect of the present invention they are not repeated here.

According to a tenth aspect, the present invention envisages a method for deploying a room smoke extraction device implementing a method for deploying a link that is the subject of the present invention, which comprises:
a step of fixing a winch configured to open an opening panel of an opening of the room;
a step of short-range pairing with an alarm control unit;
a step of capturing a value representative of a physical magnitude;
a detection step for determining a piece of information representative of the state of the opening panel as a function of the captured value;
a step of spread-spectrum wireless communication with the alarm control unit for emitting at least one piece of information representative of the opening panel state detected and for receiving a wireless signal; and
a step of controlling the winch, to command the opening or closing of the opening panel according to a received signal.

Thanks to these provisions, using spread-spectrum technology enables robust communication between the device and the alarm control unit.

According to an eleventh aspect, the present invention envisages a protection device implementing a method for deploying a link that is the subject of the present invention, which comprises:
a mechanical linkage part between a portable extinguisher and a fixed mount;
a means for pairing with an alarm control unit;
a sensor of a value representative of a physical magnitude;
a detector configured to determine a piece of information relative to the extinguisher as a function of the captured value; and
a means for spread-spectrum wireless communication with the alarm control unit configured to emit at least one piece of information relative to the extinguisher detected and to receive a wireless signal.

These provisions allow the extinguisher to be made communicating with regard to the alarm control unit. In this way, the device can communicate information, periodically for example, representative of a maintenance operation to be carried out. As this communication is two-way, the device can receive, from the alarm control unit, a command to carry out a verification of the working condition of an element of the device to which the device responds by transmitting a value captured. In addition, using spread-spectrum transmission technology makes it possible to reduce the impact of the electromagnetic noise surrounding the device during device/alarm control unit transmissions.

In some embodiments, the device that is the subject of the present invention comprises a means for determining an identifier of the portable extinguisher, the communication means being configured to emit a signal representative of the identifier detected.

These embodiments have the advantage of enabling information relative to a portable extinguisher detected to be transmitted to the alarm control unit.

In some embodiments, the detector is configured to determine a piece of information representative of a change in the identifier of the extinguisher fixed to the mount.

The advantage of these embodiments is that they make it possible to identify when a portable extinguisher associated to one mount is positioned on another mount by a user. It is possible, in this way, to warn the user of the incorrect positioning of the extinguisher.

In some embodiments, the device that is the subject of the present invention comprises a means for determining the extinguishing agent type of the extinguisher, the communication means being configured to emit a signal representative of the extinguishing agent type detected.

The advantage of these embodiments is that they enable the alarm control unit to identify the extinguishing agent type of each extinguisher fixed to a device paired with the control unit.

In some embodiments, the detector is configured to determine a piece of information representative of a change in the extinguishing agent type of the extinguisher fixed to the mount.

These embodiments have the advantage of making it possible to warn a user of a possible incorrect positioning of the extinguisher fixed to the mount if this mount is configured to only receive a specific type of extinguisher.

In some embodiments, the device that is the subject of the present invention comprises a means for broadcasting a visual and/or audible alarm configured to be activated according to a signal received.

These embodiments have the advantage, if several devices, comprising extinguishers of different types, are close, of enabling a user to identify the right extinguisher to be used according to the type of fire to be extinguished.

In some embodiments, the means for broadcasting an alarm is configured to be activated as a function of a piece of data representative of an extinguishing agent of the signal received.

The advantage of these embodiments is that they enable an alarm to be broadcast when the extinguishing agent of the extinguisher linked to the mount is identical to the piece of data representative of an extinguishing agent. This alarm enables a user, when several extinguishers are available, to quickly identify which extinguisher to take to effectively fight a fire handled optimally by a specific extinguishing agent.

In some embodiments, the means for broadcasting an alarm is configured to be activated as a function of a piece of data representative of a type of fire of the signal received.

The advantage of these embodiments is that they enable an alarm to be broadcast when the extinguishing agent of the extinguisher linked to the mount makes it possible to fight the type of fire of the signal. This alarm enables a user, when several extinguishers are available, to quickly identify which extinguisher to take to effectively fight a fire handled optimally by a specific extinguishing agent.

In some embodiments, the device that is the subject of the present invention comprises a bolt configured to lock the mechanical linkage as a function of a signal, comprising a fire type identifier, received and of the extinguishing agent type of the extinguisher determined.

The advantage of these embodiments is that, if several devices, comprising extinguishers of different types, are close, they prevent a user from picking up an extinguisher that does not match the type of fire detected.

In some embodiments, the device that is the subject of the present invention comprises a means for measuring a length of time since a change to a physical magnitude captured by the sensor, the communication means being configured to emit a warning signal when the length of time measured is longer than a predefined limit time.

These embodiments make it possible to detect, for example, the mechanical linkage not being utilized during a predefined length of time and to determine, from this detection, a piece of information relative to the need to carry out a maintenance operation on the device.

In some embodiments, the device that is the subject of the present invention comprises a means for measuring the variation in the physical magnitude captured by the sensor over a predefined limit time, the communication means being configured to emit a warning signal when the variation measured is longer than a predefined limit time.

These embodiments have the advantage of making it possible, for example, to detect a leak in the extinguisher when the mass of the extinguisher falls rapidly compared to the expected reduction linked to the use of the extinguisher.

In some embodiments, the communication means is configured to:
receive a signal representative of carrying out a maintenance operation on the device; and
emit a piece of information representative of a maintenance operation to be carried out when a length of time since the reception of the signal representative of carrying out a maintenance operation is longer than a predefined limit time.

The advantage of these embodiments is that they make it possible to transmit a piece of information representative of the need to carry out a maintenance operation on the device when a predefined length of time is reached since the last reception of a signal from the alarm control unit representative of a maintenance operation being carried out.

In some embodiments, the device that is the subject of the present invention comprises:
a means for verifying the working condition of the communication means as a function of a signal received, from the alarm control unit, by the communication means after the verification means has commanded the communication means to emit a standard piece of information to the alarm control unit; and
a means for activating a visual and/or audible alarm as a function of the signal received.

These embodiments have the advantage of enabling an operating fault of the communication means to be identified quickly.

In some embodiments, the verification means is configured to perform a verification when a length of time since the reception of a last signal emitted by the alarm control unit is longer than a predefined limit time.

These embodiments enable the working condition of the pairing between the device and the alarm control unit to be verified automatically when the communication means has not been utilized for a predefined length of time.

In some embodiments, the device that is the subject of the present invention comprises a means for controlling the working condition of the sensor, configured to command the communication means to emit a piece of information representative of the working condition of the sensor.

The advantage of these embodiments is that they enable an automatic diagnostic of an operating fault of the sensor.

In some embodiments:
the sensor captures the pressure exerted by the extinguisher on the mechanical linkage; and
the detector determines a piece of information representative of the presence of the fixed extinguisher as a function of the pressure captured.

These embodiments have the advantage of making it possible to automatically identify the presence of an extinguisher fixed to the device.

In some embodiments, the device that is the subject of the present invention comprises a means for calibrating the pressure sensor when the extinguisher is initially fixed to the mount, the detector determining a piece of information representative of the filling of the extinguisher as a function of the pressure captured after the calibration of the sensor.

The advantage of these embodiments is that they make it possible to quickly identify the filling state of the extinguisher from the alarm control unit.

According to a twelfth aspect, the present invention envisages a portable extinguisher implementing a method for deploying a link that is the subject of the present invention, which comprises a protection device that is the subject of the present invention.

As the aims, advantages and features of the portable extinguisher are similar to those of the protection device that is the subject of the present invention, they are not repeated here.

According to a thirteenth aspect, the present invention envisages an extinguisher mount implementing a method for deploying a link that is the subject of the present invention, which comprises a protection device that is the subject of the present invention.

As the aims, advantages and features of the extinguisher mount are similar to those of the protection device that is the subject of the present invention, they are not repeated here.

According to a fourteenth aspect, the present invention envisages a system for protecting a site, which comprises:
an element amongst a protection device that is the subject of the present invention, a portable extinguisher that is the subject of the present invention or an extinguisher mount that is the subject of the present invention; and
a portable communicating alarm control unit configured to be paired and communicate with the element.

As the aims, advantages and features of the device that is the subject of the site protection system of the present invention are similar to those of the site protection device that is the subject of the present invention, they are not repeated here.

According to a fifteenth aspect, the present invention envisages a method for deploying a protection device, which comprises:
a step of mechanically linking a mount to a wall;
a step of mechanically linking a portable extinguisher to the fixed mount by utilizing a mechanical linkage part;
a step of short-range pairing with a portable communicating alarm control unit;
a step of capturing a value representative of a physical magnitude;
a detection step for determining a piece of information relative to the extinguisher as a function of the captured value; and
a step of spread-spectrum wireless communication with the alarm control unit to emit at least one piece of information relative to the extinguisher detected and to receive a wireless signal.

Thanks to the use of spread-spectrum technology, robust communication between the device and the alarm control unit is made possible.

The features of the various aspects of the present invention are intended to be combined to give other embodiments of the methods and devices that are the subjects of the present invention.

### BRIEF DESCRIPTION OF THE FIGURES

Other advantages, aims and particular features of the invention will become apparent from the non-limiting description that follows of at least one particular embodiment of the device and the method that are the subjects of the present invention, with reference to drawings included in an appendix, wherein:

FIG. 1 shows, schematically, a first particular embodiment of the device for protecting a site that is the subject of the present invention;

FIG. 2 represents, in the form of a logical diagram, steps in a first particular embodiment of the method for protecting a site that is the subject of the present invention;

FIG. 3 represents, schematically, a first particular embodiment of the device for ventilating a room that is the subject of the present invention,

FIG. 4 shows, schematically, a second particular embodiment of the device for protecting a site that is the subject of the present invention;

FIG. 5 represents, in the form of a logical diagram, steps in a particular embodiment of the method for ventilating a site that is the subject of the present invention;

FIG. 6 represents, schematically, a particular embodiment of the device for extracting smoke from a room that is the subject of the present invention;

FIG. 7 represents, schematically, a third particular embodiment of the device for protecting a site that is the subject of the present invention;

FIG. 8 represents, in the form of a logical diagram, steps in a first particular embodiment of the deployment method that is the subject of the present invention;

FIG. 9 represents, schematically, a fourth particular embodiment of the device for protecting a site that is the subject of the present invention;

FIG. 10 represents, schematically, a particular embodiment of the portable extinguisher that is the subject of the present invention;

FIG. 11 represents, schematically, a particular embodiment of the extinguisher mount that is the subject of the present invention;

FIG. 12 represents, schematically, a particular embodiment of the protection system that is the subject of the present invention;

FIG. 13 represents, in the form of a logical diagram, steps in a second particular embodiment of the deployment method that is the subject of the present invention;

FIG. 14 represents a logical diagram of particular steps of the device for deploying a link that is the subject of the present invention;

FIG. 15 represents, schematically, a particular embodiment of the device for deploying a link that is the subject of the present invention; and

FIG. 16 represents, schematically, a particular embodiment of the device for deploying a link that is the subject of the present invention.

### DESCRIPTION OF EXAMPLES OF REALIZATION OF THE INVENTION

The present description is given as a non-limiting example.

The term “short-range” refers to a distance of less than one tenth of the communication range.

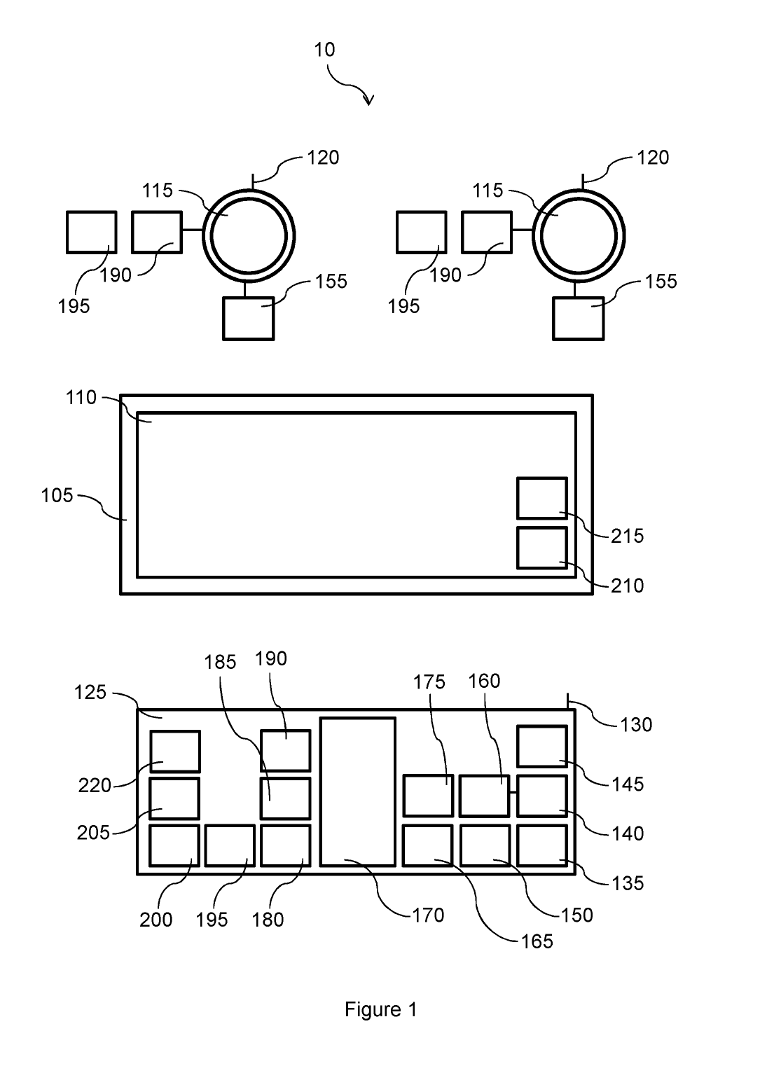

FIG. 1, which is not to scale, shows an embodiment of the device 10 that is the subject of the present invention. This device 10 comprises:
a mount 105, configured to be fixed to a wall, that comprises:
   a removable fastener 110 for a portable communicating alarm control unit 125;
   a means 210 for locking the fastener; and
   a power supply means 215 for a battery 220 of a portable communicating alarm control unit 125;
at least one fixed sensor 115 of a value representative of a physical magnitude, each of which comprises:
   a spread-spectrum wireless transmission means 120;
   a means 155 for pairing with the portable communicating alarm control unit 125;
   a means 190 for verifying the working condition of this sensor 115; and
   a means 195 for transmitting a piece of data representative of this working condition;
the portable communicating alarm control unit 125, which comprises:
   a spread-spectrum wireless transmission means 130 for communicating with at least one sensor 115;
   a means 135 for short-range wireless pairing, utilizing the wireless transmission means 130, the portable communicating alarm control unit 125 with at least one sensor 115, which comprises a means 160 for measuring the reception strength of the pairing request signal emitted by the pairing means 155 of a sensor 115;
   a detector 140;
   a means 145 for selecting a signal emitted by a sensor 115, the selection means 145 selecting the emitted signal having the strongest reception by the alarm control unit 125;
   a means 150 for triggering the pairing means 135;
   a means 165 for recording the reception strength of a signal emitted by a sensor 120 during a predefined length of time;
   a means 170 for displaying the reception strength recorded;
   a means 175 for entering at least one piece of information; and
   a control means 180 for commanding the storing of each piece of information entered at a sensor 120;
   a means 185 for detecting at least one identifier representative of another protected site emitted by at least one sensor of said protected site;
   a means 190 for verifying the working condition of the portable control unit 125;
   a means 195 for transmitting a piece of data representative of this working condition;
   a means 200 for storing a path passing through at least one sensor 115;
   a means 205 for displaying the stored path; and
   a battery 220.

The mount 105 is, for example, a housing configured to be screwed to a wall of the site to be protected. This mount 105 comprises a removable fastener 110 for a portable communicating alarm control unit 125 that is, for example, a hollow frame in the mount 105. This frame is configured to adopt the shapes of the alarm control unit 125 when the alarm control unit 125 is fixed to the mount 105. This frame comprises in particular an outlet in which the alarm control unit 125 is plugged, enabling the alarm control unit 125 to be fixed. The mount 105 also comprises a means for locking 210 the fastener 110 that is, for example, an electronic or mechanical bolt preventing the fastener 110 being removed from the alarm control unit 125. The mount 105 comprises a power supply means 215 for a battery 220 of a portable communicating alarm control unit 125 that is, for example, an electrical cable configured to enable the battery 220 to be powered by the electric current from the mains. In some variants, the power supply means 215, the locking means 210 and/or the fastener 110 are merged.

The device 10 also comprises fixed sensors 115. Each sensor 115 supplying a value representative of a physical magnitude. For example, this sensor 115 measures the air temperature of the site to be protected or the smoke density in the air of the site to be protected. This sensor 115 comprises a spread-spectrum wireless transmission means 120 that is, for example, a wireless antenna. This transmission means 120 is configured to emit at least one piece of data representative of the value captured or to receive a wireless signal. This transmission means 120 gives the sensor 115 an upward and downward communication capability with the alarm control unit 125. The sensor 115 also comprises a means for pairing 155 with the portable communicating alarm control unit 125 that is, for example, an electronic circuit configured to receive a pairing command from the transmission means 120. This pairing command also comprises, for example, a pseudo-random sequence of values “1” and “−1” generated once by the alarm control unit 125, during the pairing of the alarm control unit 125 with the sensor 115.

The pairing means 155 compels the transmission means 120 to logically multiply the data emitted by the transmission means 120 with the pseudo-random sequence. In this way, the spectrum of the emitted signal is spread over a plurality of frequencies, the strength of each portion of the signal over a frequency becoming weaker than the strength of the ambient electromagnetic noise. In addition, the pairing means 155 compels the transmission means 120 to correlate the signals received by the transmission means 120 with the pseudo-random sequence so as to extract the usable signal from the electromagnetic noise. In some variants, the transmission means 120 uses other known spread-spectrum techniques such as, for example, frequency-hopping spread-spectrum. The pairing is performed when the following steps:
generating a pseudo-random sequence;
transmitting the sequence from the alarm control unit 125 to the sensor 115; and
pairing command by the pairing means 155, have been performed.

The pairing means 155 is configured to wirelessly emit a pairing request signal until the sensor 115 is paired. When the alarm control unit 125 receives the request signal, the alarm control unit 125 emits a signal for the sensor 115 comprising the pseudo-random sequence. In some variants, the alarm control unit 125 emits a pairing request signal and the sensor 115, in response to receiving this request, emits a signal accepting the pairing request. In these variants, the alarm control unit 125 emits a signal comprising the pseudo-random sequence, for the sensor 115, on receiving the acceptance signal.

The sensor 115 also comprises a means 190 for verifying the working condition of this sensor 115 that is, for example, an electronic circuit configured to emit a standard signal to which the sensor 115 must react. If the sensor 115 reacts in the expected way, the verification means 190 detects that the sensor is in good working condition. Conversely, if the sensor 115 does not react, or reacts in an unexpected way, the verification means 190 detects a malfunction. In some variants, the verification means 190 comprises a date-stamping means (not shown) making it possible to determine a date of a last maintenance operation for the sensor 115. This date is obtained, for example, by receiving a signal representative of the fact that a maintenance operation has been carried out on the sensor 115. When a predefined length of time has been reached or exceeded between the current data measured by the date-stamping means and the data of the last maintenance, the verification means 190 detects that the sensor requires a maintenance operation.

Lastly, the sensor 115 comprises a means for transmitting 195 a piece of data representative of the working condition detected by the verification means 190 that is, for example, a wireless antenna. This transmission means 195 is configured to emit a piece of data representative of the working condition to the alarm control unit 125. In some variants, the means for transmitting 195 a piece of data representative of the working condition and the spread-spectrum wireless transmission means 120 are merged.

Lastly, the device 10 comprises a portable communicating alarm control unit 125. This alarm control unit 125 comprises a spread-spectrum wireless transmission means 130 for communicating with at least one sensor 115 that is, for example, a wireless antenna. This alarm control unit 125 also comprises a means 135 for short-range wireless pairing, utilizing the wireless transmission means 130, the portable communicating alarm control unit 125 with at least one sensor 115. This pairing means 135 receives, from each sensor 115 of the device 10, a signal comprising a pairing request when the alarm control unit 125 is positioned a short distance from at least one sensor 115. This pairing means 135 comprises a means 160 for measuring the reception strength of the pairing request signal emitted by the pairing means 155 of a sensor 115 that is, for example, an electronic circuit connected to the transmission means 130. This electronic circuit measures the reception strength of each signal received, which enables the alarm control unit 125 to estimate the distance between the alarm control unit 125 and the sensor 115 emitting the signal received.

The alarm control unit 125 also comprises a means 145 for selecting a signal emitted by a sensor 115, the selection means 145 selecting the emitted signal having the strongest reception by the alarm control unit 125. This selection means 145 is, for example, an electronic circuit configured to compare the reception strength of each signal emitted by a sensor 115 and to select the strongest of these. This selection means 145 feeds a display means 170, such as a screen, for example, so as to indicate to a user the reception strength of the signal emitted.

If the user wants to initiate the pairing between the alarm control unit 125 and the sensor 115 having emitted the selected signal, the user utilizes a means for triggering 150 the pairing means 135. This triggering means 150 is, for example, a button pressing on which causes the pairing between the alarm control unit 125 and the sensor 115. In some variants, this triggering means 150 is configured to measure pressure exerted on a portion of the display means 170 and to trigger pairing when this pressure is greater than a predefined limit value. When the triggering means 150 commands the pairing between the alarm control unit 125 and the sensor 115, the alarm control unit 125 emits a command comprising a pseudo-random sequence enabling the sensor 115 to perform spectrum spreading. Once the pairing has been achieved, the control unit 125 and the sensor 115 communicate using the spread-spectrum technique.

In some variants, the pairing between the alarm control unit 125 and the sensor 115 is performed when the reception strength measured by the selection means 145 is greater than a predefined limit value.

In other variants, the selection means 145 selects one received signal, emitted by the pairing means 155 of a sensor 120, for which the reception strength is strongest, and one received signal, emitted by the pairing means of another sensor, for which the reception strength is the second strongest. In these variants, the means 160 for measuring the signal strength of a signal performs a comparison between the two reception strengths of the selected signals. Lastly, in these variants, the pairing means 135 pairs the portable communicating alarm control unit 125 with the sensor emitting the signal having the greatest strength if said comparison is greater than a predefined limit value.

The alarm control unit 125 also comprises a means 165 for recording the reception strength of a signal emitted by the sensor 120 during a predefined length of time that is, for example, an electronic circuit recording the reception strength of each signal emitted. This recording is displayed on the display means 170 so as to allow a user to observe whether, during the predefined length of time, the alarm control unit 125 has been moved closer to or farther from a selected sensor 115.

The alarm control unit 125 comprises a means 175 for entering at least one piece of information that is, for example, a physical keypad or virtual keypad on the display means 170. This entry means 175 allows a user to enter information concerning the sensor 115 synchronized, eg its location.

The alarm control unit 125 comprises a means 185 for detecting at least one identifier representative of another protected site emitted by at least one sensor of said protected site that is, for example, an electronic circuit configured to detect a piece of data representative of the other protected site. In some variants, once the alarm control unit 125 has generated a pseudo-random sequence, the detection means 185 correlates this pseudo-random sequence with each incoming signal during a predefined length of time and, if a signal emitted by a non-paired sensor is detected, the alarm control unit 125 generates another pseudo-random sequence. In other variants, the detection means performs this verification after each sensor 115 pairing and during the fixing of the alarm control unit 125 to the mount 105. In the case where a sensor 115 was paired before the detection means 185 detects that the pseudo-random sequence is already being used by another site, the display means 170 displays a recommendation, intended for a user, to perform a new pairing of the control unit 125 with each sensor 115 already paired.

The alarm control unit 125 also comprises a control means 180 for commanding the storing of each piece of information entered at a sensor 120 that is, for example, an electronic circuit configured to generate a storage request intended for a sensor 115. Once each piece of information has been entered, the alarm control unit 125 transmits the pieces of information to the sensor 115 so that the sensor 115 associates these pieces of information to each emission of a piece of data representative of the physical value captured. In some variants, these pieces of information comprise a piece of data indicative of the frequency at which the pieces of information are to be associated to the signals emitted. In addition, this storage control means 180 commands the sensor 115 to store a protected site identifier.

The alarm control unit comprises a means 190 for verifying the working condition of the portable control unit 125 that is, for example, an electronic circuit configured to emit a standard signal to which the alarm control unit 125 must react. If the alarm control unit 125 reacts in the expected way, the verification means 190 detects that the alarm control unit 125 is in good working condition. Conversely, if the alarm control unit 125 does not react, or reacts in an unexpected way, the verification means 190 detects a malfunction. In some variants, the verification means 190 comprises a date-stamping means (not shown) making it possible to determine a date of a last maintenance operation for the alarm control unit 125. This date is obtained, for example, by receiving a signal representative of the fact that a maintenance operation has been carried out on the alarm control unit 125. When a predefined length of time has been reached or exceeded between the current data measured by the date-stamping means and the data of the last maintenance, the verification means 190 detects that the alarm control unit 125 requires a maintenance operation.

Lastly, the alarm control unit 125 comprises a means for transmitting 195 a piece of data representative of the working condition detected by the verification means 190 that is, for example, a wireless antenna. This transmission means 195 is configured to emit a piece of data representative of the working condition. In some variants, the means for transmitting 195 a piece of data representative of the working condition and the spread-spectrum wireless transmission means 130 are merged.

The alarm control unit 125 comprises a means 200 for storing a path passing through at least one sensor 115 that is, for example, a read-only memory storing a series of instructions, intended for a user, making it possible to realize the path passing through at least one sensor 115. The path is displayed on the display means 205 that is, for example, a screen. In some variants, this means for displaying 205 the stored path is merged with the display means 170.

The alarm control unit 125 also comprises a detector 140 configured to detect an anomaly in each piece of data representative of the captured value emitted by the transmission means 120 of the sensor 115. This detector 140 is, for example, an electronic circuit configured to compare the value of each piece of data received to a predefined limit value. If the value of this received piece of data is greater than the predefined limit value, the detector 140 detects an anomaly. In some embodiments, the predefined limit value is adaptive. When the detector 140 detects an anomaly, the alarm control unit 125 transmits, for example, a signal representative of the detection of an anomaly to visual and/or audible alarms, not shown, present on the site. In some variants, on detecting an anomaly, the alarm control unit 125 transmits an alarm signal to the emergency services, for example the fire service. In these, the alarm control unit 125 associates to the signal representative of detecting an anomaly a piece of information representative of the sensor 115 having captured the value representative of the physical magnitude.

The alarm control unit 125 also comprises a battery 220 allowing the alarm control unit 125 to be powered when this alarm control unit 125 is removed from the mount.

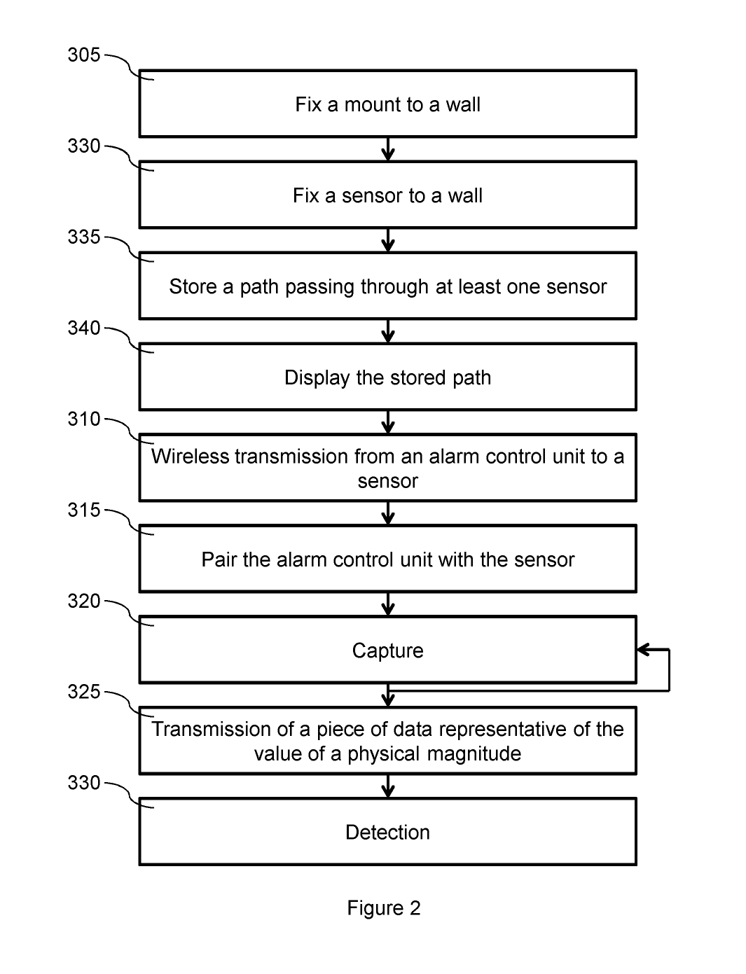

FIG. 2 shows a particular embodiment of the method that is the subject of the present invention. This method comprises:
a step 305 of fixing a mount to a wall, the mount comprising a removable fastener for a portable communicating alarm control unit;
a step 330 of fixing at least one sensor to a wall of the site;
a step 335 of storing a path passing through at least one sensor;
a step 340 of displaying the stored path;
a step 310 of wireless transmission, by a portable communicating alarm control unit, for communicating with at least one sensor;
a step 315 of short-range wireless pairing with at least one sensor;
at least one step 320 of a fixed sensor capturing a value representative of a physical magnitude, that comprises a step 325 of spread-spectrum wireless transmission during which at least one piece of data representative of the value captured is emitted or a wireless signal is received; and
a detection step 330 during which a piece of data representative of the detection of an anomaly is transmitted if at least one value captured is greater than a predefined limit value.

The step 305 of fixing a mount to a wall is carried out, for example, by screwing the mount onto the wall.

The step of fixing 330 at least one sensor to a wall of the site is carried out, for example, by screwing each sensor in different rooms of the site to be protected.

The step of storing 335 a path passing through at least one sensor is carried out, for example, by utilizing a read-only memory in which a series of instructions, intended for a user, is downloaded, so that this user can go to each sensor on the stored path.

The step 340 of displaying the stored path is carried out, for example, by utilizing a screen on the alarm control unit.

The step 310 of wireless transmission, by a portable communicating alarm control unit, for communicating with at least one sensor is carried out by utilizing an antenna. This transmission step 310 is carried out after a step, not shown, of the emission, by a sensor, of a pairing request.

The step 315 of short-range wireless pairing with at least one sensor is carried out by a pseudo-random sequence being transmitted from the alarm control unit to the sensor. The sensor records this pseudo-random sequence and logically multiplies every message emitted by the sensor, before carrying out the emission, so as to perform spectrum spreading.

In some variants, the method comprises a step of verifying the pairing, during which the sensor emits a signal multiplied by the pseudo-random sequence to which the alarm control unit responds if the control unit detects this signal. If the alarm control unit responds, the sensor confirms the pairing.

Each step 320 of a fixed sensor capturing a value representative of a physical magnitude is carried out by utilizing a thermometer or an optical smoke sensor, for example.

This method comprises a step of spread-spectrum wireless transmission 325 during which at least one piece of data representative of the value captured is emitted that is carried out, for example, by utilizing a wireless antenna.

The method comprises a detection step 330 that is carried out, for example, by utilizing an electronic circuit detecting whether at least one captured value transmitted by a sensor is greater than a predefined limit value. During this detection step 330, if an anomaly is detected, the alarm control unit transmits a signal representative of detecting an anomaly to at least one sound and/or light alarm, and/or to the emergency services by means of the telephone network.

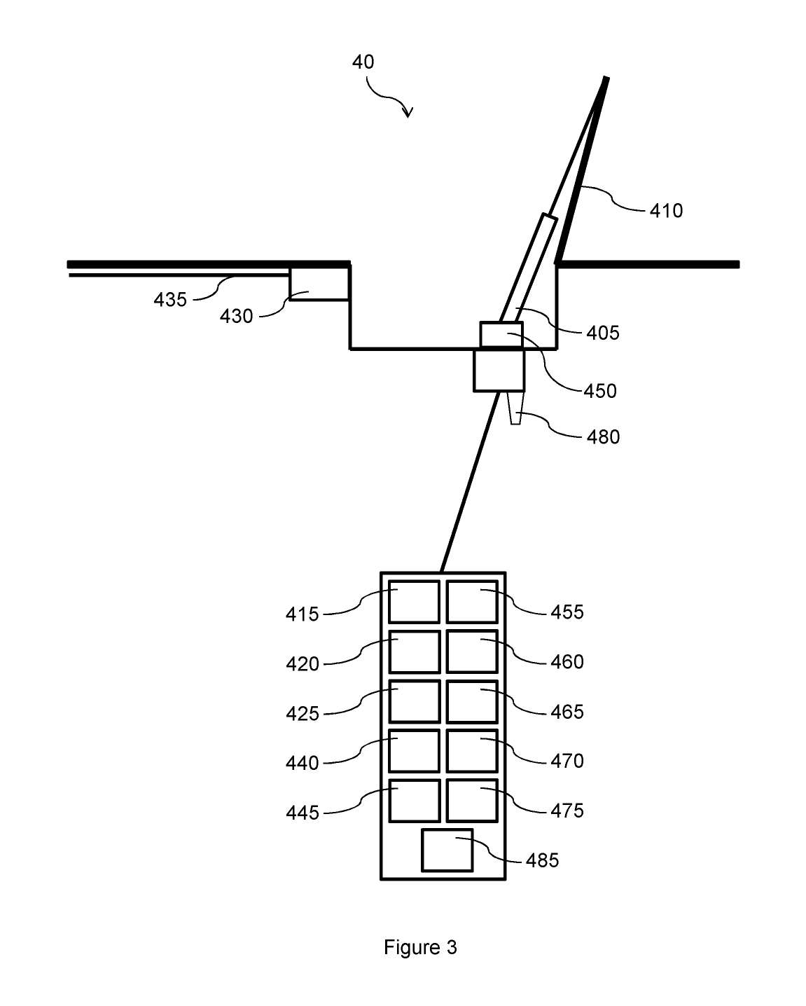

FIG. 3, which is not to scale, shows an embodiment of the device 40 that is the subject of the present invention. This device 40 comprises:
an actuator 405, configured to open an opening panel 410 of the room, that comprises a rotary motor 450;
a means 415 for pairing with an alarm control unit;
a means 420 for controlling the actuator 405;
a means 425 for communicating wirelessly with the alarm control unit;
a means 430 for storing electrical energy, charged by an electrical power supply source 435;
a sensor 440 of a value representative of a physical magnitude;
a detector 445 configured to determine a piece of information relative to the opening panel 410 as a function of the captured value,
a means 455 for measuring a length of time since a change to a physical magnitude captured by the sensor 440;
a sensor 460 of a value representative of a physical magnitude of the device's environment;
a fire detector 465;
a means 470 for verifying the working condition of the communication means 425;
a means 475 for activating a visual and/or audible alarm 480 as a function of the signal received; and
a means 485 for verifying the working condition of a sensor, 440 and 460.

The actuator 405 is, for example, a mechanical actuator comprising a cylindrical tube in which a piston is set in motion by the action of a rotary motor 450. This rotary motor 450 is, for example, a brushless motor. When the piston of the actuator 405 is deployed, the opening panel 410 is opened, and the smoke contained in the room comprising the opening panel 410 can leave this room.

The actuator 405 is controlled by a means 420 for controlling the actuator 405. When a signal to open the opening panel 410 is received by the communication means 425, this control means 420 transmits to the motor 450 a command to activate the actuator 405 so as to open the opening panel 410. Conversely, this control means 420 transmits to the motor 450 a command to close the opening panel 410 when a close command is received by the communication means 425.

The communication means 425 is, for example, an antenna for emitting or receiving wireless signals utilizing spread-spectrum transmission technology. In order to utilize spread-spectrum communication, the communication means 425 is based on the device 40 being paired with the alarm control unit. This pairing utilizes a pairing means 415.

The pairing means 415 is, for example, an electronic circuit configured to receive a pairing command emitted by the alarm control unit from the transmission means 425. This pairing command also comprises, for example, a pseudo-random sequence of values “1” and “−1” generated once by the alarm control unit, during the pairing of the alarm control unit with the device 40.

The pairing means 415 compels the communication means 425 to logically multiply the data emitted by the communication means 425 with the pseudo-random sequence.

The pairing means 415 is configured to wirelessly emit a pairing request signal until the device 40 is paired. When the alarm control unit receives the request signal, the alarm control unit emits a signal for the device 40 comprising the pseudo-random sequence. In some variants, the alarm control unit emits a pairing request signal and the device, in response to receiving this request, emits a signal accepting the pairing request. In these variants, the alarm control unit emits a signal comprising the pseudo-random sequence, for the device, on receiving the acceptance signal.

The communication means 425 receives, for example, two types of ‘open’ signals:
a smoke evacuation signal; and
a room ventilation signal.

A smoke evacuation signal corresponds to an alarm signal emitted by the alarm control unit. This signal is representative of the detection, by the alarm control unit, of a fire as a function of data transmitted by the fire detectors associated to sensors.

A room ventilation signal corresponds to a signal emitted by a ventilation control unit, which can also be the alarm control unit. This ventilation control unit is, for example, a portable communicating terminal such as a tablet making it possible to command the alarm control unit to emit a ventilation signal. The ventilation signal comprises a piece of information representative of a degree of opening for the opening panel 410.

The communication means 425 transmits the two types of signals to the control means 420 of the actuator 405.

When the control means 420 receives a ventilation signal, the control means 420 commands the activation of the actuator 405 resulting in the slow opening of the opening panel 410. As this operation requires low electrical amperage, the motor 450 activating the actuator 405 draws its power supply from an electrical power supply source 435 that is, for example, a mains power supply. In addition, the control means 420 is configured to control a degree of opening of the opening panel 410 according to the piece of information representative of an opening degree for the opening panel 410 in the ventilation signal.

When the control means 420 receives a smoke evacuation signal, the control means 420 commands the actuator 405 to open the opening panel 410 quickly. As this quick opening requires high electrical amperage, the control means 420 commands an electrical energy storage means 430 to power the motor 450.

The electrical energy storage means 430 is, for example, a supercapacitor charged by the electrical power supply source 435. This storage means 430 is charged by the electrical power supply 435 while the control means 420 is not commanding the storage means 430 to power the motor 450. In this way, the storage means 430 acts as a safety system for the device 40.

The sensor 440 of a value representative of a physical magnitude is, for example, a Hall Effect sensor positioned near the brushless motor 450. The sensor 440 counts the number of revolutions made by the motor 450 and the direction of each of the revolutions counted.

The detector 445 is, for example, an electronic circuit configured to determine a piece of information relative to the opening panel 410 according to the number of revolutions counted by the sensor 440. Thus, if a captured number of revolutions made by the motor 450 in a direction corresponding to opening the opening panel 410 is greater than a captured number of revolutions made by the motor 450 in a direction corresponding to closing the opening panel 410, the detector 445 detects that the opening panel 410 is open. In addition, the detector 445 detects a degree of opening of the opening panel 410 according to a difference between the number of revolutions captured by the sensor 440 in each direction of the motor 450.

The communication means 425 is configured to transmit a signal representative of the detected degree of opening of the opening panel 410 to the alarm control unit.

The means for measuring 455 a length of time since a change to a physical magnitude captured by the sensor 440 is, for example, an electronic clock. This electronic clock is configured to measure a length of time beginning when a captured physical magnitude is changed. Once this physical magnitude is changed, the length of time measured is reset. When the length of time measured is longer than a predefined limit time, the measurement means 455 transmits a signal representative of the predefined limit time being exceeded to the communication means 425.

In that case, the communication means 425 is configured to transmit a signal representative of the predefined value time being exceeded.

The sensor 460 of a value representative of a physical magnitude of the device's environment is, for example, an optical smoke detector.

The fire detector 465 is, for example, an electronic circuit. This electronic circuit is configured to detect a fire as a function of an amount of smoke in the air captured by the sensor 460 for example.

The communication means 425 is configured to send the alarm control unit a signal representative of the detection of a fire when the detector 465 detects a fire.

The means 470 for verifying the working condition of the communication means 425 is, for example, an electronic circuit. This electronic circuit verifies the working condition of the communication means 425 as a function of a signal received, from the alarm control unit, by the communication means 425 after the verification means 470 has commanded the communication means 425 to emit a standard piece of information to the alarm control unit. If no signal is received from the alarm control unit, the verification means 470 determines that the communication means 425 is faulty. In some variants, if no signal is received, the verification means 470 performs a second verification as confirmation. If the signal received conforms to the expected signal, for example comprising a specific code transmitted by the communication means 425 to the alarm control unit, the verification means 470 determines that the communication means 425 is working.

The verification means 470 is configured to perform a verification when a length of time since the reception of a last signal emitted by the alarm control unit is longer than a predefined limit time. This provision makes it possible to verify the state of the pairing between the device 40 and the alarm control unit.

When the verification means 470 determines that the communication means 425 is faulty, the verification means 470 commands the means 475 for activating a visual and/or audible alarm 480 to activate the visual and/or audible alarm 480. This activation means 475 is, for example, an electronic circuit configured to emit a command to blink or to emit a periodic sound signal according to the type of alarm 480 controlled. The visual and/or audible alarm 480 is, for example, a light-emitting diode, possibly associated with a loudspeaker.

The means 485 for verifying the working condition of the sensors 440 and 460 is, for example, an electronic circuit configured to send to the sensors 440 and 460 a signal representative of a physical magnitude and to measure the reaction of each sensor 440 and 460. If the reaction of at least one sensor, 440 and/or 460, conforms to a reaction expected by the verification means 485, the verification means 485 determines that each said sensor, 440 and/or 460, is in working condition. Conversely, if the reaction of at least one sensor, 440 and/or 460, does not conform to a reaction expected by the verification means 485, the verification means 485 determines that each said sensor, 440 and/or 460, is faulty.

The verification means 485 is configured to command the communication means 425 to send the alarm control unit a piece of information representative of the working condition of each sensor, 440 and 460.

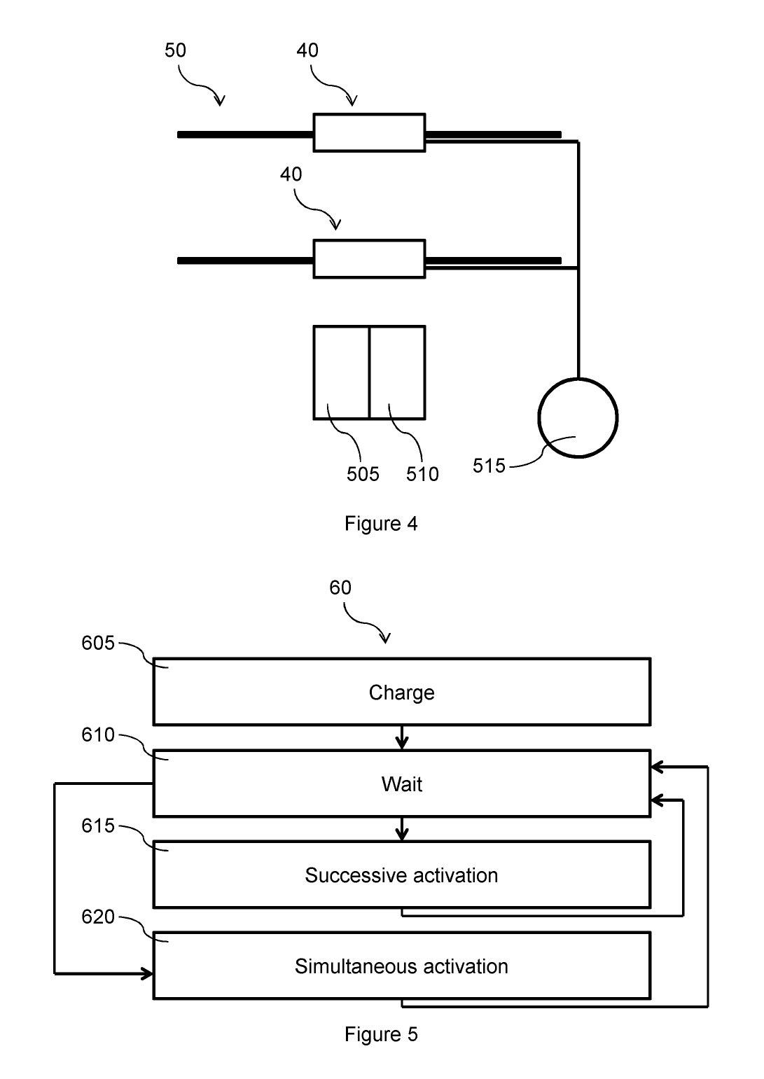

FIG. 4, which is not to scale, shows an embodiment of the device 50 for protecting a site that is the subject of the present invention. This device 50 comprises:
two devices 40 for ventilating a room, as described in FIG. 3;
an alarm control unit 505 paired with each room ventilation device 40, configured to transmit a smoke evacuation signal when a fire is detected;
a ventilation control unit 510 configured to transmit a ventilation signal to at least one ventilation device 40;
a common power supply source 515 powering each ventilation device 40.

The two devices 40 are powered by a common power supply source 515. This power supply source 515 is, for example, a mains power supply connected to each energy storage means (not shown) of each ventilation device 40.

The alarm control unit 505 is, for example, an electronic circuit connected wirelessly to sensors, not shown, of values representative of physical magnitudes. These sensors transmit the values captured to the alarm control unit 505 and, according to these captured values, the alarm control unit 505 detects, or not, a fire. Such a captured physical magnitude is, for example, a density of smoke in the ambient air. If this smoke density is greater than a limit value predefined by the alarm control unit 505, the alarm control unit 505 detects the presence of a fire in the site. When a fire is detected, the alarm control unit 505 transmits a smoke evacuation signal to each ventilation device 40.

Each ventilation device 40 powers the opening of an opening panel (not shown) by means of an actuator (not shown) by the storage means previously charged by the common power supply source 515.

The ventilation control unit 510 is, for example an electronic circuit associated to the alarm control unit 505. The ventilation control unit 510 communicates with a user interface, not shown, located remotely, or not, from the ventilation control unit 510. This user interface allows a user to control a degree of opening of at least one opening panel. Depending on the degree of opening of at least one opening panel entered by a user, the ventilation control unit 510 transmits a ventilation signal to each ventilation device 40 controlling an actuator configured to open each said opening panel.

Each ventilation device 40 receiving a ventilation signal powers the opening of the opening panel of the ventilation device 40 by means of the common power supply source 515. When at least two ventilation devices 40 must be activated, the ventilation control unit 510 orders the consecutive activation of each ventilation device 40 that has to be activated. In this way, the electrical amperage necessary to activate one or more devices 40 is not greater than the electrical amperage available at the common power supply source 505. In some variants, the device 50 comprises more than two devices 40 and the electrical amperage available at the ventilation control unit 510 makes it possible, for example, to power only two ventilation devices 40 simultaneously. In these variants, the ventilation control unit 510 commands the simultaneous opening of two ventilation devices 40 first and then, subsequently, the opening of the third ventilation device 40.

In this embodiment, with a standard power supply source 515, it is possible to command a simultaneous, quick opening of the opening panels “in parallel”, or a consecutive opening of the opening panels “in series” when no fire risk has been detected.

FIG. 5 shows a logical diagram of particular steps of the method 60 that is the subject of the present invention. This method 60 for ventilating a site by a plurality of ventilation devices, each equipped with an actuator for opening an opening panel, comprises:
a step 605 of charging, in each ventilation device, an energy storage means associated to said ventilation device, by powering the electrical energy storage means with an electrical power supply source common to the ventilation devices;
a step 610 of each device waiting for an ‘open’ or ‘close’ control signal for the opening panels, received from either an alarm control unit or from a ventilation control unit;
if an ‘open’ or ‘close’ control signal for the opening panels is received from the ventilation control unit, a step 615 of successively opening or closing opening panels, powering the actuators by the power supply common to the ventilation devices, the amperage output by the common power supply being less than the sum of the amperages necessary to simultaneously power the actuators; and
if an ‘open’ control signal for the opening panels is received from the alarm control unit, a step 620 of simultaneously opening the opening panels, powering the actuator of each device with the energy storage means associated to said device.

The charging step 605 is realized, for example, by wiring each ventilation device to a common power supply source. This common power supply source is, for example, the mains power supply. In addition, this power supply source is configured to power an actuator for opening an opening panel of a device when said device receives a ventilation signal. This charging step 605 is also realized by wiring a supercapacitor to each ventilation device. This supercapacitor is powered by the common power supply source and is charged by means of this power supply source. In addition, each energy storage means is configured to power an actuator for opening an opening panel of the ventilation device when said device receives a smoke evacuation signal.

The waiting step 610 is realized, for example, by utilizing a wireless communication means of each ventilation device connected to the alarm control unit. This communication means is configured to receive a signal to open the opening panel of the device. This ‘open’ signal is either:
a smoke evacuation signal; or
a ventilation signal.

The step 615 of successively opening or closing opening panels is carried out, for example, by utilizing each actuator associated to an opening panel to be opened powered by the common power supply source.

The simultaneous opening step 620 is carried out, for example, by utilizing each actuator associated to an opening panel to be opened powered by the energy storage means associated to the device comprising the actuator.

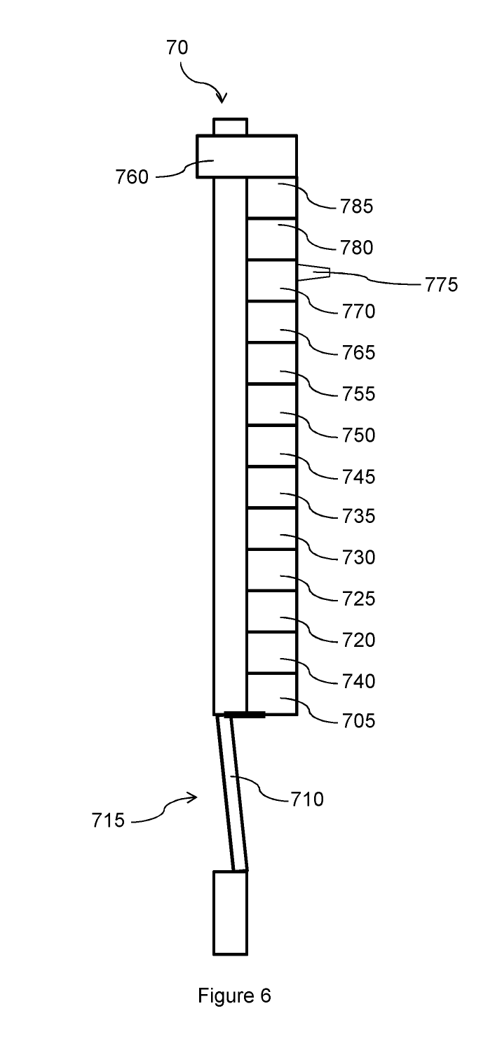

FIG. 6, which is not to scale, shows an embodiment of the device 70 for extracting smoke from a room that is the subject of the present invention. This device 70 comprises:
a winch 705 configured to open an opening panel 710 closing an opening 715 of the room;
a means 720 for pairing with an alarm control unit;
a sensor 725 of a value representative of a physical magnitude;
a detector 730 configured to determine a piece of information representative of the state of the opening panel as a function of the captured value;
a means 765 for measuring a length of time since a change to a physical magnitude captured by the sensor 725; the communication means being configured to emit a warning signal when the length of time measured is longer than a predefined limit time;
an additional sensor 745 of a value representative of a physical magnitude;
a fire detection means 750;
a communication means 735;
a means 740 for controlling the winch;
a ventilation means 760 configured to blow or exhaust the air inside the room according to the environmental conditions detected;
a means 765 for verifying the working condition of the communication means 735 as a function of a signal received, from the alarm control unit, by the communication means after the verification means has commanded the communication means to emit a standard piece of information to the alarm control unit;
a means 770 for activating a visual and/or audible alarm 775 as a function of the signal received;
a means 780 for verifying the working condition of the sensor 725, configured to command the communication means 735 to emit a piece of information representative of the working condition of the sensor; and
a means 785 for measuring the variation in the physical magnitude captured by the sensor 725 over a predefined limit time, the communication means being configured to emit a warning signal when the variation measured is longer than a predefined limit time.

The winch 705 is, for example, a winch motorized by a motor, not shown. This winch 705 allows a cable (not shown) to be wound or unwound by rotation of a shaft of the motor. One end of the cable is fixed to a structural element (not shown) of the winch 705, while the other end is fixed to an opening panel 710 closing an opening 715. This opening panel 710 is naturally unbalanced such that, it the opening panel 710 were not retained by the winch 705, the opening panel 710 would open, under the effect of the Earth's gravity, so as to not block the opening 715. For example, in the case of a vertical opening 705, a lower portion of the opening panel 710 is fixed to a hinge and the opening panel 710 is positioned obliquely. In this way, without the action of the cable of the winch 705 fixed on an upper portion of the opening panel 710, the opening panel 710 would open.

The pairing means 720 is, for example, an electronic circuit configured to receive a pairing command emitted by the alarm control unit from the transmission means 735.

The pairing means 720 is configured to wirelessly emit a pairing request signal until the device 70 is paired. When the alarm control unit receives the request signal, the alarm control unit emits a signal for the device 70 comprising the pseudo-random sequence. In some variants, the alarm control unit emits a pairing request signal and the device, in response to receiving this request, emits a signal accepting the pairing request. In these variants, the alarm control unit emits a signal comprising the pseudo-random sequence, for the device, on receiving the acceptance signal. The sensor 725 is, for example, a rev counter for the motor of the winch 705.

This rev counter is realized, for example, by fixing two magnets, distinguishable by their magnetic field, on a roller fixed to a shaft of the motor, where the angle between the two magnets relative to the axis of rotation of the roller is approximately 90°. A fixed magnet is positioned along the shaft so as to be opposite the two magnets in rotation on the roller at one instant of the roller's rotation. Depending on the sequence in which the magnetic fields are identified, the sensor 725 is able to identify the direction of rotation of the shaft. Therefore, each time an identification sequence is repeated, the sensor 725 captures the fact that the motor has made one revolution in one direction.

In some variants, this sensor 725 comprises a means for reinitializing the sensor 725 configured to reset the current revolution count of the sensor 725. These variants make it possible, in particular, during the installation of the device 70, to tare the sensor 725 once the installation is finished.

The means for measuring 765 a length of time since a change to a physical magnitude captured by the sensor 725 is, for example, an electronic clock configured to measure a length of time since the opening panel was opened. When this length of time measured is longer than a predefined limit time, the measurement means 765 commands the communication means 735 to emit a signal representative of this predefined limit time being exceeded.

The means for measuring 785 the variation in the physical magnitude captured by the sensor 725 over a predefined limit time is, for example, an electronic circuit configured to measure the variation in the value captured. When the variation measured is greater than a predefined limit value, the measurement means 785 commands the communication means 735 to emit a signal representative of this predefined limit value being exceeded.

The detector 730 is, for example, an electronic circuit connected to the sensor 725 and configured to determine a piece of information relative to the opening panel 710 according to data captured by the sensor 725. This detector 730 is configured to bear a piece of information associating a direction of rotation and an action of the opening panel 710. For example, a certain rotation direction of the motor indicates that the opening panel 710 opens the opening 715, whereas the other direction of rotation indicates that the opening panel 710 closes the opening 715. The detector 730 detects, for example, that if the total number of revolutions made in the opening direction is greater than the total number of revolutions made in the closing direction, the opening panel 710 is open. The detector 730 detects that the opening panel 710 closes the opening 715 closed when the total number of revolutions made in the opening and closing directions are equal. The detector 730 is also configured to determine a piece of information as a function of a variation in a captured value. Thus, if the opening panel 710 has not been activated for a year, for example, the detector 730 detects that maintenance must be carried out on the device 70 and transmits a piece of information relative to this detection to the communication means 735.

In some variants, the detector 730 is limited to transmitting to the communication means 735 the result of subtracting the total number of revolutions in the opening direction from the total number of revolutions in the closing direction. In these variants, it is the alarm control unit that interprets this subtraction and deduces the position of the opening panel 710 from it.

The additional sensor 745 is, for example, an optical smoke sensor configured to determine smoke saturation in the ambient air.

If this smoke saturation captured by the additional sensor 745 is greater than a predefined limit value, the smoke detection means 750 detects the presence of a fire in the room. This detection means 750 is, for example, an electronic circuit connected to the sensor 745. The detection means 750 transmits a piece of information relative to the detection of a fire to the communication means 735 for transmitting to the alarm control unit.

The detection means 750 also comprises a means for determining 755 environmental conditions that is, for example, an electronic circuit connected to a gas sensor (not shown) configured to determine an amount of smoke or graphite in the air. Depending on this content, the detection means 750 inhibits, or not, the opening of the opening panel 710, possibly under the control of the alarm control unit. This detection means 750 can also be a presence detector configured to inhibit the opening panel 710 from opening when a person is detected close to the opening panel 710 and the environmental conditions detected could put the person in danger if the opening panel 710 is opened. In these variants, the detection means 750 can also detect an intrusion by the opening closed by the opening panel 710.

If the detection means 750 detects a fire of a type requiring the opening panel 710 to be opened, the control means 740 commands the opening of the opening panel 710. The association between the environmental conditions and the need to open the opening panel 710 can be prerecorded be the detection means 750 or parameterized by the alarm control unit.

The means for spread-spectrum wireless communication 735 with the alarm control unit is, for example, an antenna for emitting or receiving wireless signals. This communication means 735 is configured to emit at least one piece of information representative of the detected state of the opening panel 710 or to receive a wireless signal. This piece of information is, for example, a piece of information relative to the need to carry out maintenance on the device 70 according to the piece of information determined by the detector 730.

The communication means 735 is configured to:
emit a signal representative of a predefined limit time, measured by the means for measuring 765 a length of time, being exceeded;
emit a signal representative of a predefined limit value being exceeded by the variation measured by the means for measuring 785 a variation;
receive a signal representative of carrying out a maintenance operation on the device 70;
receive a command to verify the working condition of the winch 705;
receive a signal representative of the working condition of the winch 705;
emit a piece of information representative of a maintenance operation to be carried out when a length of time since the reception of the signal representative of carrying out a maintenance operation is longer than a predefined limit time;
emit a piece of information representative of the detection of a fire when the fire detection means 750 detects a fire;
receive an ‘open’ or ‘close’ control signal for the opening panel 710.

The means 765 for verifying the working condition of the communication means 735 is, for example, an electronic circuit. This electronic circuit verifies the working condition of the communication means 735 as a function of a signal received, from the alarm control unit, by the communication means 735 after the verification means 765 has commanded the communication means 735 to emit a standard piece of information to the alarm control unit. If no signal is received from the alarm control unit, the verification means 765 determines that the communication means 735 is faulty. In some variants, if no signal is received, the verification means 765 performs a second verification as confirmation. If the signal received conforms to the expected signal, for example comprising a specific code transmitted by the communication means 735 to the alarm control unit, the verification means 765 determines that the communication means 735 is working.

The verification means 765 is configured to perform a verification when a length of time since the reception of a last signal emitted by the alarm control unit is longer than a predefined limit time. This provision makes it possible to verify the state of the pairing between the device 70 and the alarm control unit. The verification means can also carry out a verification on receiving a command from the alarm control unit.

When the verification means 765 determines that the communication means 735 is faulty, the verification means 765 commands the control means 770 of the alarm 775 to activate a visual and/or audible alarm 775.

The ventilation means 760 is, for example, a controlled mechanical ventilation system configured to draw air from outside the room into the room or vice-versa, depending on the environmental conditions detected.

The means 780 for verifying the working condition of the sensor 725 is, for example, an electronic circuit configured to send to the sensor 725 a signal representative of a physical magnitude and to measure the reaction of the sensor 725. If the reaction of the sensor 725 conforms to a reaction expected by the verification means 780, the verification means 780 determines that the sensor 725 is in working condition. Conversely, if the reaction of the sensor 725 does not conform to a reaction expected by the verification means 780, the verification means 780 determines that the sensor 725 is faulty.

The verification means 780 is configured to command the communication means 735 to send the alarm control unit a piece of information representative of the working condition of the sensor 725. In this way, if the sensor 725 is faulty, the alarm control unit commands the means 770 for activating a visual and/or audible alarm 775 to emit a signal representative of this operating fault.

The control means 740 is, for example, an electronic circuit configured to control the opening or closing of the opening panel 710. The opening of the opening panel 710 is commanded by:
the communication means 735 receiving a maintenance command, in which case the control means 740 orders the opening panel 710 to be opened and then closed;
the communication means 735 receiving an open command; and
the detection means 750 detecting a fire.

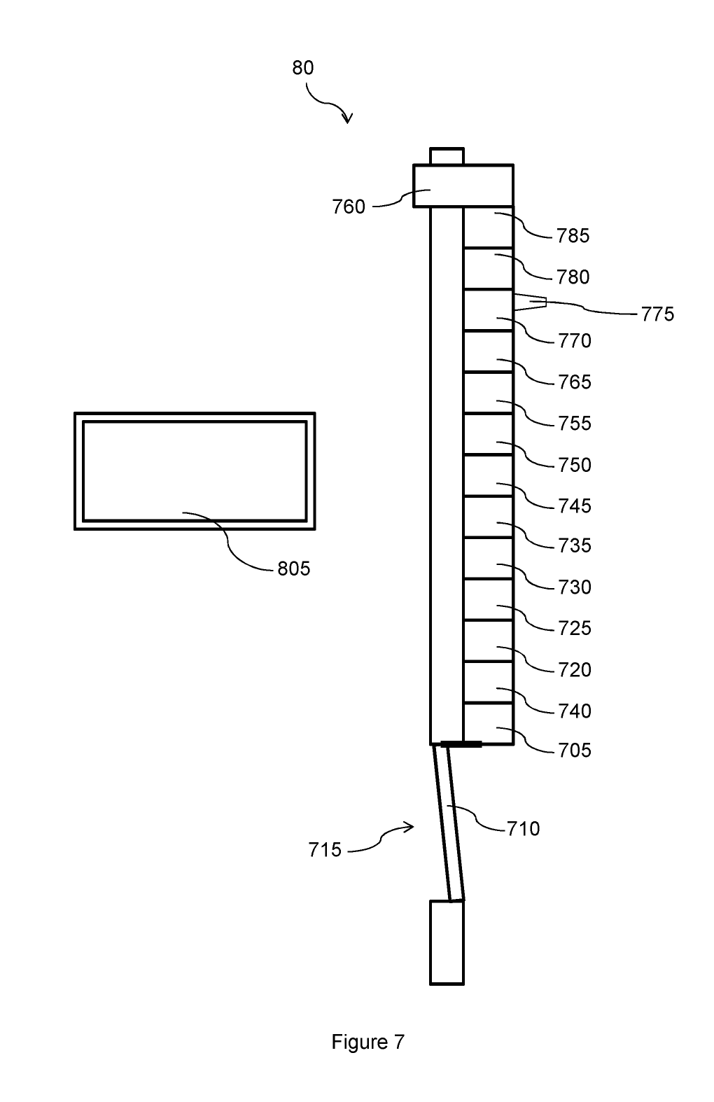

FIG. 7, which is not to scale, shows an embodiment of the device 80 for protecting a site that is the subject of the present invention. This device 80 comprises:
a device 70 as described in FIG. 6; and
an alarm control unit 805.

The alarm control unit 805 is configured to be paired with the device 70 then to receive information transmitted by the communication means 735 of the device 70. This information is transmitted by means of spread-spectrum transmission technology. In particular, the alarm control unit 805 is configured to produce a pseudo-random sequence comprising values “1” and “−1” used to perform the spectrum spreading. In some variants, the device 80 comprises a plurality of devices 70, the alarm control unit 805 being paired with each device 70.

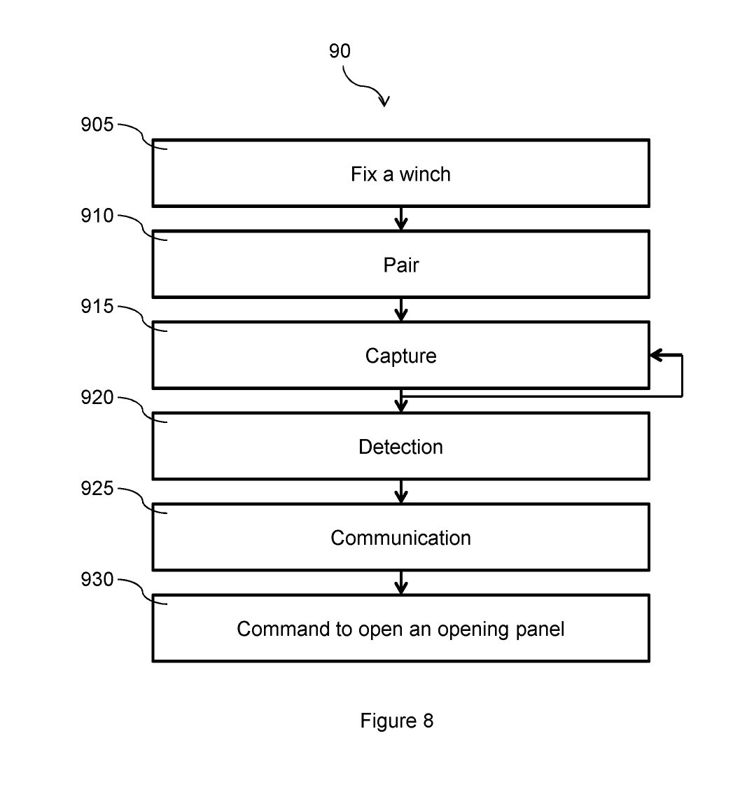

FIG. 8 shows a particular embodiment of the method 90 for deploying a room smoke extraction device that is the subject of the present invention. This method 90 comprises:
a step 905 of fixing a winch configured to open an opening panel of an opening of the room;
a step 910 of short-range pairing with an alarm control unit;
a step 915 of capturing a value representative of a physical magnitude;
a detection step 920 for determining a piece of information representative of the state of the opening panel as a function of the captured value;
a step 925 of spread-spectrum wireless communication with the alarm control unit for emitting at least one piece of information representative of the opening panel state detected and for receiving a wireless signal; and
a step 930 of controlling the winch, to command the opening or closing of the opening panel according to a received signal.

The winch fixing step 905 is carried out, for example, by screwing the winch to a wall close to an opening closed by the opening panel. The opening panel is connected to the winch by a cable such that, when the cable is unwound, the opening panel opens to allow smoke in the room to be evacuated.

The pairing step 910 is carried out, for example, by transmitting a pseudo-random sequence from the alarm control unit to the smoke extraction device. The protection device records this pseudo-random sequence and logically multiplies every message emitted by the device, before carrying out the emission, so as to perform spectrum spreading.

In some variants, the method 90 comprises a step of verifying the pairing, during which the device emits a signal multiplied by the pseudo-random sequence to which the alarm control unit responds if the control unit detects this signal. If the alarm control unit responds, the device confirms the pairing.

The capture step 915 is carried out, for example, by utilizing a rev counter of the number of revolutions made by a motor of the winch.

The detection step 920 is carried out, for example, by utilizing an electronic circuit configured to determine whether the opening panel is open.

The communication step 925 is carried out, for example, by utilizing an antenna for emitting or receiving wireless signals configured to use spread-spectrum transmission technology once the device has been paired. During this communication step 925, the device emits a piece of information determined during the detection step 920 to the alarm control unit.

The control step 930 is carried out, for example, by utilizing a control means configured to cause the opening panel to be opened when the smoke extraction device receives a signal from the alarm control unit comprising a command to open the opening panel.

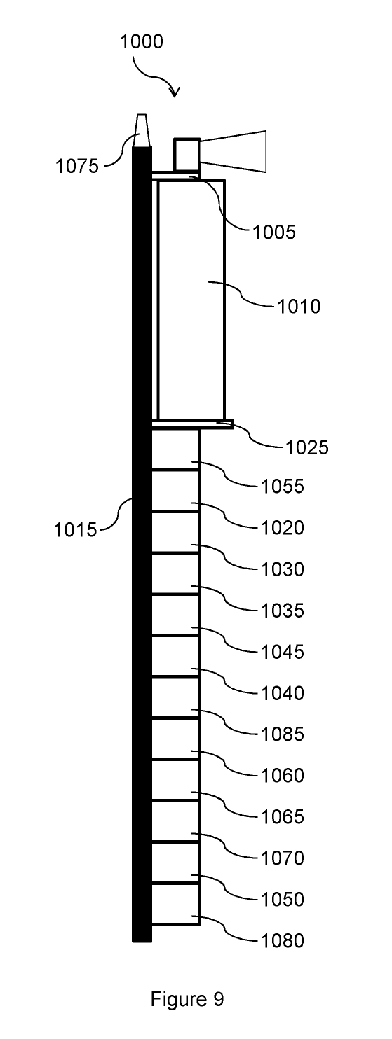

FIG. 9, which is not to scale, shows an embodiment of the device 1000 that is the subject of the present invention. This device 1000 comprises:
a mechanical linkage part 1005 between a portable extinguisher 1010 and a fixed mount 1015;
a means 1020 for pairing with an alarm control unit, not shown;
a sensor 1025 of a value representative of a physical magnitude;
a means 1055 for controlling the working condition of the sensor 1025;
a means 1040 for measuring a length of time since a change to the physical magnitude captured;
a means 1085 for measuring the variation in the physical magnitude captured over a predefined limit time;
a means 1060 for calibrating the pressure sensor 1025 when the extinguisher 1010 is initially fixed to the mount;
a detector 1030;
a means 1035 for spread-spectrum wireless communication with the alarm control unit;
a means 1045 for verifying the working condition of the communication means 1035;
a means 1050 for activating a means 1075 for broadcasting a visual and/or audible alarm;
a means 1065 for determining an identifier of the portable extinguisher 1010;
a means 1070 for determining the extinguishing agent type of the extinguisher 1010;
the broadcasting means of the means for broadcasting 1075 a visual and/or audible alarm, configured to be activated as a function of a signal, comprising a fire type identifier, received and the extinguishing agent type of the extinguisher 1010 determined; and
a bolt 1080 configured to lock the mechanical linkage 1005 as a function of a signal, comprising a fire type identifier, received and of the extinguishing agent type of the extinguisher 1010 determined.

The fixed mount 1015 is, for example, a metal plate screwed to a wall.

The mechanical linkage part 1005 between the portable extinguisher 1010 and the fixed mount 1015 is, for example, a mechanical connection clamp configured to surround a portion of the extinguisher at least partially. This mechanical connection clamp is configured to be able to be pulled off by the user in the event of a fire.

The pairing means 1020 is, for example, an electronic circuit configured to receive a pairing command emitted by the alarm control unit from the transmission means 1035.

The pairing means 1020 is configured to wirelessly emit a pairing request signal until the device 1000 is paired. When the alarm control unit receives the request signal, the alarm control unit emits a signal for the device 1000 comprising the pseudo-random sequence. In some variants, the alarm control unit emits a pairing request signal and the device, in response to receiving this request, emits a signal accepting the pairing request. In these variants, the alarm control unit emits a signal comprising the pseudo-random sequence, for the device, on receiving the acceptance signal.

The sensor 1025 of a value representative of a physical magnitude is, for example, a pressure sensor positioned under the base of the portable extinguisher 1010 when it is fixed to the fixed mount 1015. In some variants, the sensor 1025 measures the pressure exerted by the portable extinguisher 1010 on the mechanical linkage 1005.

The means for controlling 1055 the working condition of the sensor 1025 is, for example, an electronic circuit configured to send to the sensor 1025 a signal representative of a physical magnitude and to measure the reaction of the sensor 1025. If the reaction of the sensor 1025 conforms to a reaction expected by the control means 1055, the control means 1055 determines that the sensor 1025 is in working condition. Conversely, if the reaction of the sensor 1025 does not conform to a reaction expected by the control means 1055, the control means 1055 determines that the sensor 1025 is faulty.

The control means 1055 sends, for example, a signal representative of a change in pressure exerted by the portable extinguisher 1010. If the sensor 1025 detects a change in pressure similar to the change in pressure sent, the operating means 1055 determines that the sensor 1025 is working. If the sensor 1025 detects a change in pressure similar to the change in pressure sent, the operating means 1055 determines that the sensor 1025 is working.

The control means 1055 is configured to command the communication means 1035 to send the alarm control unit a piece of information representative of the working condition of the sensor 1025. In this way, if the sensor 1025 is faulty, the alarm control unit commands the means for activating 1050 the means for emitting 1075 a visual and/or audible alarm to emit a signal representative of this operating fault.

The means 1040 for measuring a length of time since a change to a physical magnitude captured by the sensor 1025 is, for example, an electronic clock configured to measure the length of time since a change to the value of the physical magnitude captured.

The means 1085 for measuring the variation in the physical magnitude captured by the sensor 1025 over a predefined limit time is, for example, an electronic circuit configured to determine the drift of the physical magnitude captured over a predefined length of time. If the value of this drift is greater than a predefined value, corresponding to the expected loss of extinguishing agent the measurement means 1085 transmits a signal representative of this predefined value being exceeded to the communication means 1035.

The means for calibrating 1060 the pressure sensor 1025 when the extinguisher 1010 is initially fixed to the fixed mount 1015 is, for example, an electronic circuit activated by pressing a button, not shown. When this button is pressed, the calibration means 1060 measures the pressure exerted by the extinguisher 1010 on the sensor 1025 and transmits this value to the detector 1030. The means for determining 1065 an identifier of the portable extinguisher 1010 is, for example, an image sensor coupled to an optical detector configured to recognize an identification number imprinted on the extinguisher 1010. In some variants, this determination means 1065 is a radio-frequency identification (“RFID”) sensor, the extinguisher 1010 comprising an RFID chip allowing this extinguisher 1010 to be identified.

The means for determining 1070 an extinguishing agent type of the extinguisher 1010 is, for example, radio-frequency identification (“RFID”) of the extinguisher 1010, the extinguisher 1010 comprising an RFID chip allowing the extinguishing agent of this extinguisher 1010 to be identified. In some variants, the means for determining 1065 an identifier makes it possible, based on the identifier, to determine the extinguishing agent of the extinguisher.

The detector 1030 is, for example, an electronic circuit. When the extinguisher 1010 is placed on the sensor 1025 after the mechanical linkage 1005 had been undone, the difference in pressure exerted by the extinguisher 1010 since the initial mechanical linkage of the extinguisher 1010 detected by the detector 1030 enables the detector 1030 to determine whether the portable extinguisher 1010 is full or not. In addition, if the sensor 1025 detects that during a predefined limit period, for example one year, the pressure exerted by the portable extinguisher 1010 has remained the same, the detector 1030 determines that a maintenance operation has to be carried out on the device 1000. Lastly, in some variants, if the detector 1030 detects that the mechanical linkage 1005 is no longer subjected to pressure from the portable extinguisher 1010, the detector 1030 determines the absence of mechanical linkage between an extinguisher 1010 and the mechanical linkage 1005. The detector 1030 is also configured to detect a change in the identifier of the extinguisher 1010 linked to the mount 1015. Lastly, the detector 1030 is configured to detect a change in the extinguishing agent type of the extinguisher 1010 linked to the mount 1015.

The means for spread-spectrum wireless communication 1035 with the alarm control unit is, for example, an antenna for emitting or receiving wireless signals. This communication means 1035 is configured to emit at least one piece of information relative to the extinguisher 1010 detected or to receive a wireless signal. This piece of information is, for example, a piece of information relative to the filling volume of the extinguisher 1010, to the mechanical linkage of an extinguisher 1010, or to the need to carry out maintenance on the device 1000 according to the piece of information determined by the detector 1030.

The communication means 1035 is configured to:
emit a piece of information representative of the identifier of the extinguisher 1010 detected;
emit a piece of information representative of the extinguishing agent type of the extinguisher 1010 detected;
emit a warning signal when the length of time measured by the means for measuring 1040 a length of time is longer than a predefined limit time;
emit a warning signal when the variation measured by the means for measuring 1085 a variation is greater than a predefined limit value;
receive a signal representative of carrying out a maintenance operation on the device 1000; and
emit a piece of information representative of a maintenance operation to be carried out when a length of time since the reception of the signal representative of carrying out a maintenance operation is longer than a predefined limit time.

The means 1045 for verifying the working condition of the communication means 1035 is, for example, an electronic circuit. This electronic circuit verifies the working condition of the communication means 1035 as a function of a signal received, from the alarm control unit, by the communication means 1035 after the verification means 1045 has commanded the communication means 1035 to emit a standard piece of information to the alarm control unit. If no signal is received from the alarm control unit, the verification means 1045 determines that the communication means 1035 is faulty. In some variants, if no signal is received, the verification means 1045 performs a second verification as confirmation. If the signal received conforms to the expected signal, for example comprising a specific code transmitted by the communication means 1035 to the alarm control unit, the verification means 1045 determines that the communication means 1035 is working.

The verification means 1045 is configured to perform a verification when a length of time since the reception of a last signal emitted by the alarm control unit is longer than a predefined limit time. This provision makes it possible to verify the state of the pairing between the device 1000 and the alarm control unit.

When the verification means 1045 determines that the communication means 1035 is faulty, the verification means 1045 commands the means 1050 for activating a visual and/or audible alarm to activate the visual and/or audible alarm. This activation means 1050 is, for example, an electronic circuit configured to emit a command to blink or to emit a periodic sound signal according to the type of alarm controlled.

The bolt 1080 is, for example, an electromagnetic bolt configured to lock the mechanical linkage 1005 as a function of a signal, comprising a fire type identifier, received and of the extinguishing agent type of the extinguisher 1010 determined. For example, if the alarm control unit communicates a signal representative of the detection of an electrical fire, and if the extinguisher 1010 comprises an extinguishing agent that is not to be used on an electrical fire, the bolt 1080 locks the mechanical linkage 1005. Thus, the bolt 1080 can comprise, in memory, a data table summarizing the authorized associations between extinguishing agents and types of fire. When an identifier of a type of fire is received by the device 1000, the bolt 1080, or a means for controlling the bolt, not shown, determines whether the association between the extinguishing agent of the fixed extinguisher 1010 and the type of fire is authorized. If yes, the bolt 1080 does not lock the mechanical linkage. If no, the bolt 1080 locks the mechanical linkage. If the bolt 1080 is no longer powered, the bolt 1080 unlocks so as to ensure a maximum level of safety.

Lastly, the means for broadcasting 1075 a visual and/or audible alarm, which is, for example, a light-emitting diode, is configured to be activated as a function of a signal, comprising a fire type identifier, received and the extinguishing agent type of the extinguisher 1010 determined. This means for broadcasting 1075 a visual and/or audible alarm has, for example, three modes of operation:
if a fire is detected by the alarm control unit and the device 10 receives a fire type identifier and/or extinguishing agent identifier that corresponds to the extinguishing agent contained in the extinguisher 1010, the diode turns green;
if a fire is detected by the alarm control unit and the device 1000 receives a fire type identifier and/or extinguishing agent identifier that does not match the extinguishing agent contained in the extinguisher 1010, the diode turns red; and
if the control means 1055 detects an operating fault of the communication means 1035, the diode turns orange and blinks.

Alternatively, the means for broadcasting 1075 an alarm emits, for example, a regular sound when the extinguishing agent of the extinguisher 1010 corresponds to the type of fire detected, so as to attract the attention of individuals nearby.

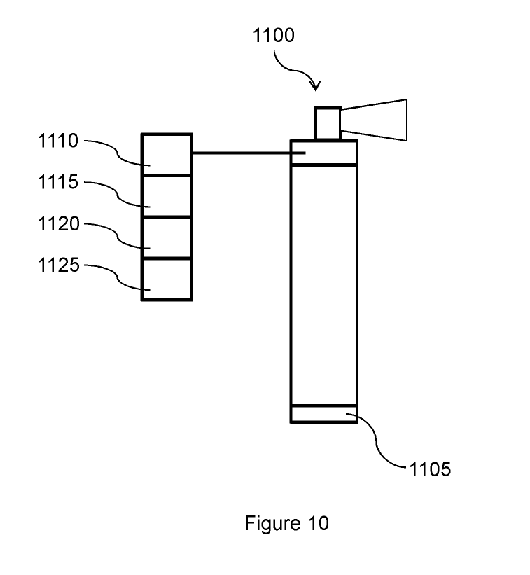

FIG. 10, which is not to scale, shows an embodiment of the portable extinguisher 1100 that is the subject of the present invention. This portable extinguisher 1100 comprises:
a part for mechanically linking 1105 with a fixed mount;
a means 1110 for pairing with an alarm control unit;
a sensor 1115 of a value representative of a physical magnitude;
a detector 1120 configured to determine a piece of information relative to the extinguisher as a function of the captured value; and
a means 1125 for spread-spectrum wireless communication with the alarm control unit configured to emit at least one piece of information relative to the extinguisher detected and to receive a wireless signal.

The mechanical linkage part 1105 between the portable extinguisher and the fixed mount is, for example, a portion of the base of the extinguisher.

The pairing means 1110 is, for example, an electronic circuit configured to receive a pairing command emitted by the alarm control unit from the transmission means 1125.

The pairing means 1110 is configured to wirelessly emit a pairing request signal until the device 1100 is paired. When the alarm control unit receives the request signal, the alarm control unit emits a signal for the device 1100 comprising the pseudo-random sequence. In some variants, the alarm control unit emits a pairing request signal and the device, in response to receiving this request, emits a signal accepting the pairing request. In these variants, the alarm control unit emits a signal comprising the pseudo-random sequence, for the device, on receiving the acceptance signal.

The sensor 1115 of a value representative of a physical magnitude is, for example, an accelerometer positioned under the base of the portable extinguisher enabling the movements made by the portable extinguisher 1100 to be measured.

The detector 1120 is, for example, an electronic circuit. If the sensor 1115 detects that during a predefined limit period, for example one year, the portable extinguisher 1100 has not moved, the detector 1120 determines that a maintenance operation has to be carried out on the device 1100.

The means for spread-spectrum wireless communication 1125 with the alarm control unit is, for example, an antenna for emitting or receiving wireless signals. This communication means 1125 is configured to emit at least one piece of information relative to the extinguisher detected or to receive a wireless signal. This piece of information is, for example, a piece of information relative to the need to carry out maintenance on the device 1100 according to the piece of information determined by the detector 1120.

The communication means 1125 is configured to:
receive a signal representative of carrying out a maintenance operation on the device 1100; and
emit a piece of information representative of a maintenance operation to be carried out when a length of time since the reception of the signal representative of carrying out a maintenance operation is longer than a predefined limit time.

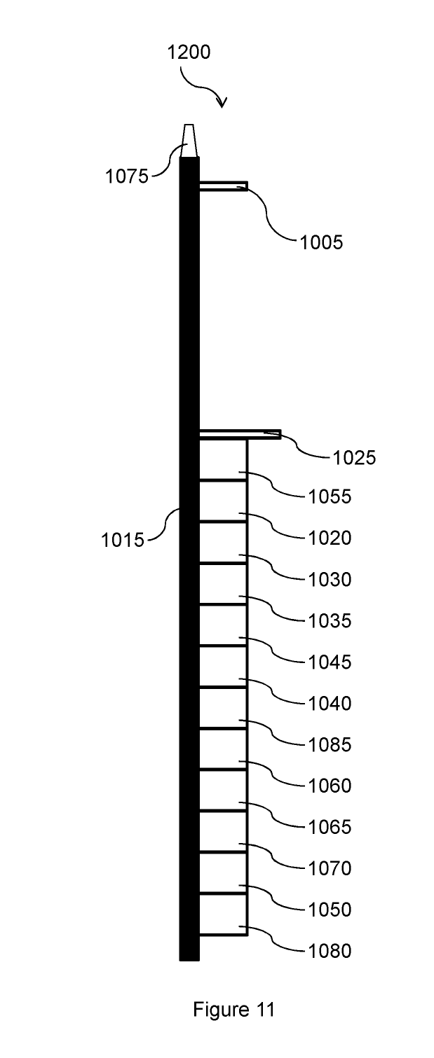

FIG. 11, which is not to scale, shows an embodiment of the mount 1200 that is the subject of the present invention. This mount 1200 comprises a protection device as described in FIG. 9 to which a portable extinguisher can be linked.

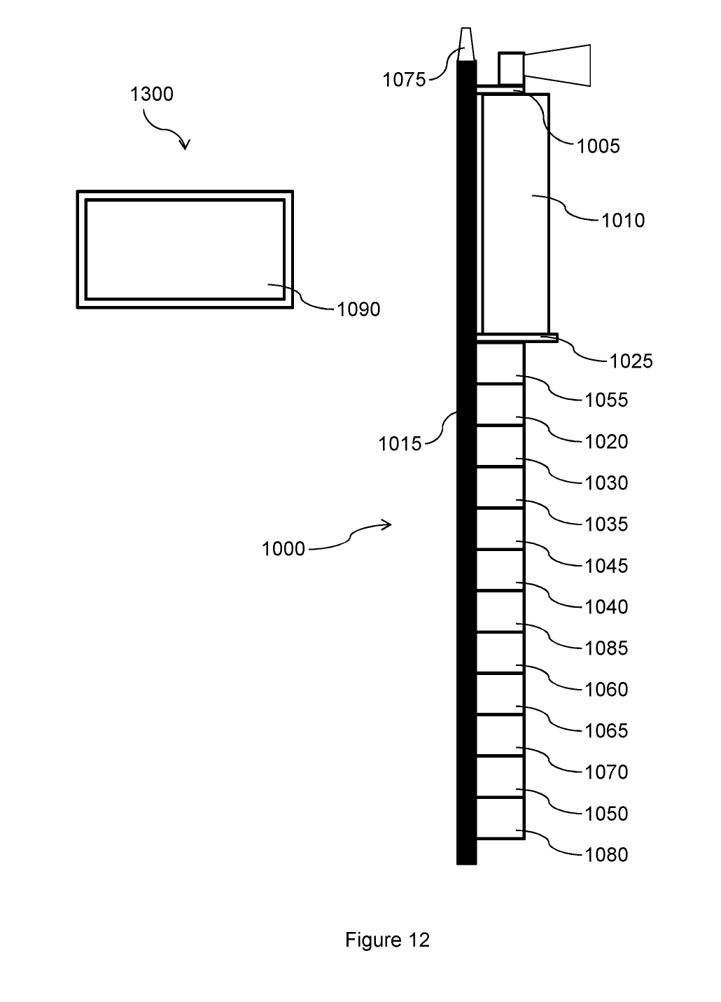

FIG. 12, which is not to scale, shows an embodiment of the protection system 1300 that is the subject of the present invention. This system 1300 comprises:
a device 1000 as described with regard to FIG. 9; and
a portable communicating alarm control unit 1090.

The portable communicating alarm control unit 1090 is configured to be paired with the device 1000 then to receive information transmitted by the communication means 1035 of the device 1000. This information is transmitted by means of spread-spectrum transmission technology. In particular, the alarm control unit 1090 is configured to produce a pseudo-random sequence comprising values “1” and “−1” used to perform the spectrum spreading.

In some variants, the device 1000 is replaced by the portable extinguisher 1100 described with regard to FIG. 10.

In other variants, the device 1000 is replaced by the extinguisher mount 1200 described with regard to FIG. 11.

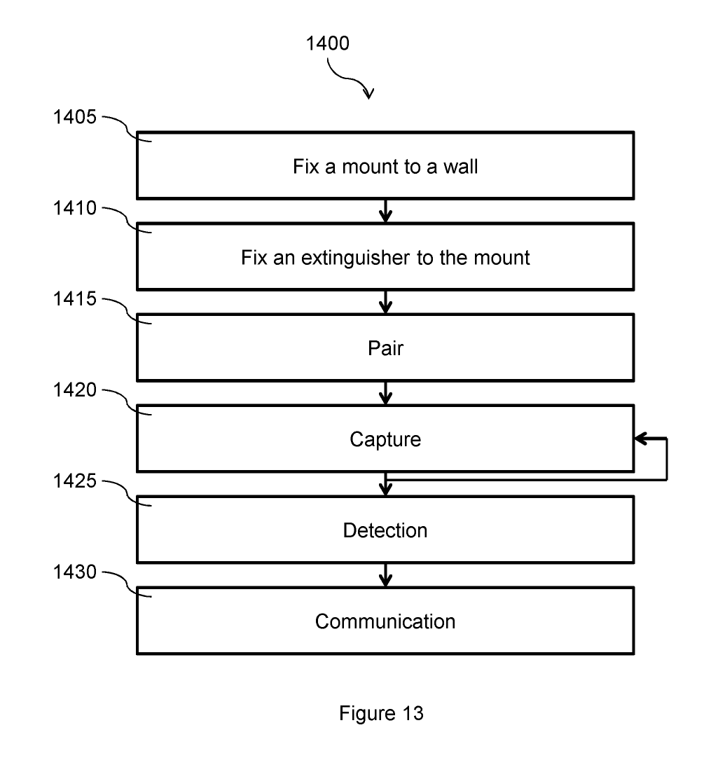

FIG. 13 shows a particular embodiment of the method 1400 for deploying a protection device that is the subject of the present invention. This method 1400 comprises:
a step 1405 of mechanically linking a mount to a wall;
a step 1410 of mechanically linking a portable extinguisher to a fixed mount by utilizing a mechanical linkage part;
a step 1415 of short-range pairing with a portable communicating alarm control unit;
a step 1420 of capturing a value representative of a physical magnitude;
a detection step 1425 for determining a piece of information relative to the extinguisher as a function of the captured value; and
a step 1430 of spread-spectrum wireless communication with the alarm control unit to emit at least one piece of information relative to the extinguisher detected and to receive a wireless signal.

The step of mechanically linking 1405 a mount is carried out, for example, by screwing the mount to a wall of a site to be protected.

The step of mechanically linking 1410 a portable extinguisher is carried out, for example, by utilizing a mechanical linkage part such as a mechanical connection clamp surrounding at least one portion of the portable extinguisher.

The pairing step 1415 is carried out, for example, by transmitting a pseudo-random sequence from the alarm control unit to the protection device. The protection device records this pseudo-random sequence and logically multiplies every message emitted by the device, before carrying out the emission, so as to perform spectrum spreading.

In some variants, the method 50 comprises a step of verifying the pairing, during which the device emits a signal multiplied by the pseudo-random sequence to which the alarm control unit responds if the control unit detects this signal. If the alarm control unit responds, the device confirms the pairing.

The capture step 1420 is carried out, for example, by utilizing a sensor of the pressure exerted by the portable extinguisher on the mount.

The detection step 1425 is carried out, for example, by utilizing an electronic circuit configured to determine whether an extinguisher is fixed to the mount as a function of the pressure exerted by the extinguisher on the mount.

The communication step 1430 is carried out, for example, by utilizing an antenna for emitting or receiving wireless signals configured to use spread-spectrum transmission technology once the device has been paired. During this communication step 1430, the device emits a piece of information determined during the detection step 1425 to the portable communicating alarm control unit.

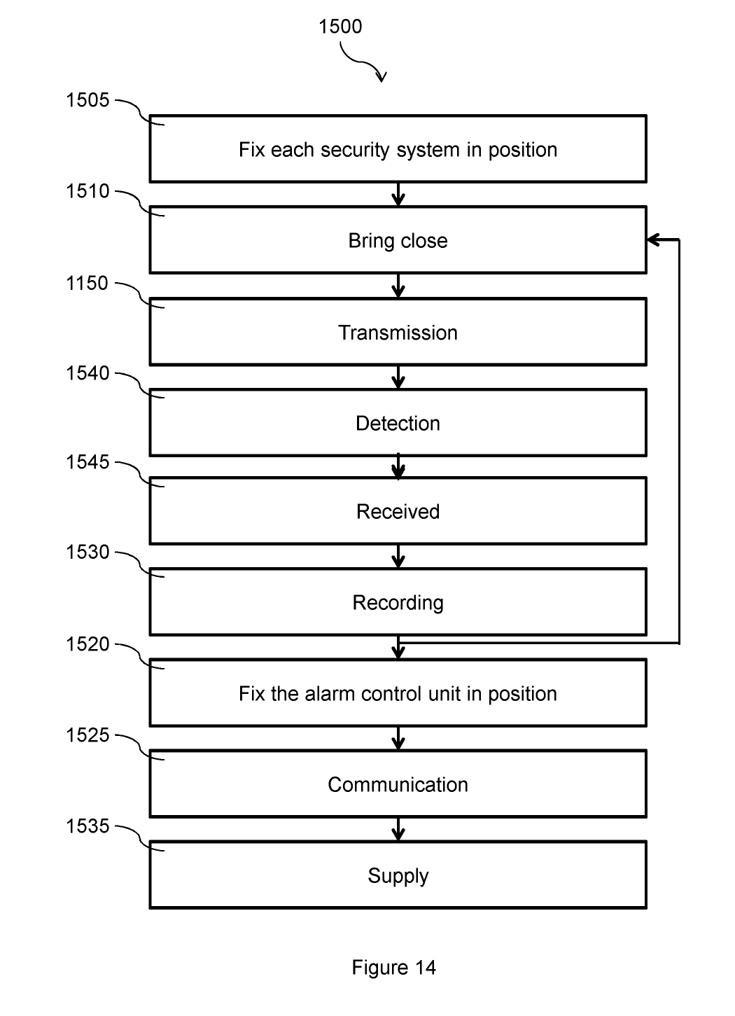

FIG. 14 shows, schematically, an embodiment of the deployment method 1500 that is the subject of the present invention. This method 1500 for deploying a link between at least one security system and an alarm control unit comprises:
a step 1505 of fixing each security system in position;
iteratively:
   a step 1510 of bringing a mobile pairing means, retaining a frequency-spreading key and comprising a short-range wireless signal transmission means, having a transmission range less than or equal to the communication range of a wireless local network, close to a fixed security system;
   a step 1515 of transmitting the frequency-spreading key to the security system via short-range wireless signals;
   a step 1540 of detecting a pairing signal as a function of a strength of a signal received according to an operating frequency of the communications means higher than a limit value;
   a step 1545 of the spreading key being received by the communication means when a pairing signal is detected; and
   a step 1530 of recording a piece of data representative of the location of the security system, at least one communication between said security system and the alarm control unit comprising a piece of data representative of the location of the security system;
a step 1520 of fixing the alarm control unit in position at a distance from at least one security system that is greater than the transmission distance of the short-range wireless signal transmission means; and
a step 1525 of communicating a security message between a communication means of at least one security system and the alarm control unit, implementing spectrum spreading depending on the spreading key;
a step of supplying 1535 an alarm signal and a piece of location information for at least one security system, this signal being emitted when a piece of data received by the alarm control unit is representative of a risk.

During the fixing step 1505, each security system is fixed in position in a site. The fixing means varies according to the system to be fixed. This fixing means comprises, for example, a mount screwed to a wall on which the security system is placed or attached. This step 1505 makes it possible, firstly, to position each security system correctly before deploying the communication links linking these systems to the alarm control unit, which prevents a positioning error following the establishment of such links before the systems are positioned.

When all or part of the security systems have been fixed in position, a pairing means is brought close by a user, for example, successively to each fixed security system. This pairing means retains a frequency-spreading key, this spreading key corresponding to a pseudo-random sequence of “1” and “−1” similar to the one described in the embodiments above. This frequency-spreading key is generated, for example, by the alarm control unit and a new spreading key can be generated when required by the alarm control unit. In some variants, the spreading key is received by the pairing means or by the alarm control unit and comes from a remote device, such as a server for example, connected to the pairing means or to the alarm control unit by a mobile or IP (for “Internet Protocol”) data network.

This pairing means comprises the short-range wireless signal transmission means for transmitting the frequency-spreading key to a security system. This transmission means is, for example, an antenna configured to transmit short-range wireless signals having a local network range, usually known under the name “LAN” (for “Local Area Network”). These wireless signals are emitted, for example, using the IEEE 802.11 standard, known as “WiFi”. In some variants, the transmission means transmits signals having a transmission range less than or equal to the transmission range of a personal network, usually known under the name “PAN” (for “Personal Area Network”). These personal networks, sometimes also called “piconets”, have an operating range of less than one hundred meters. Preferably, the transmission range utilized is less than ten meters. Preferably, the transmission range utilized is less than three meters. Such a variant utilizes, for example, the Bluetooth standard to carry out the transmission.

The transmission step 1515 is therefore carried out, for example, by utilizing the transmission means to transmit a wireless signal using one of the standards mentioned above towards the security system fixed nearby. This wireless signal comprises a piece of information representative of the frequency-spreading key.

In some variants, the transmission means 1515 transmits the piece of information representative of the frequency-spreading key using one of the frequencies utilized by the spectrum spreading in question. In these variants, the frequencies at which the security system is likely to emit or receive by means of spectrum spreading are known to both the security systems and the alarm control unit. One of these frequencies serves as the channel for transferring signal data while no spreading key has been received by the security system. This frequency can be determined before the fixing of each security system by a user parameterizing such a frequency, or during the manufacture of components making up each security system and the alarm control unit, for example.

In some variants, this frequency is not predefined, the security system capturing signals representative of electromagnetic noise on each frequency utilized by the spectrum spreading configured at the level of the security system. When the security system captures a signal having greater strength than the noise level on one of these frequencies, the security system detects that a pairing signal has been transmitted by the pairing means. The strength of this signal is greater than the noise level because of the pairing means and security system being brought close together. Once this detection step 1540 has been carried out, the security system undertakes a step of receiving 1545 a piece of information representative of the frequency-spreading key using the reception frequency of the pairing signal detected.

Once the piece of information representative of this spectrum spreading key has been received by the security system, this is recorded by a recording step (not shown) utilizing, for example, a computer memory and a controller of this memory to write the piece of information representative of the frequency-spreading key in it.

The transmission means transmits a piece of information representative of the frequency-spreading key when several spreading keys are stored by the different devices utilized and when this piece of information serves to indicate a choice among these spreading keys.

In some variants, the transmission means transmits the frequency-spreading key.

Once the key has been transmitted, a piece of information with the location of the security system is recorded during the recording step 1530 utilizing a memory and a controller of this memory of the pairing means, of the alarm control unit and of the security system. This piece of location information is written automatically by means of the detection of “GPS” (for “Global Positioning System”) type of location coordinates or manually by a user entering such information. This entry is carried out, for example, via a user interface of the pairing means, of the security system or of the alarm control unit.

Such a mode of operation can also be applied the alarm control unit in the case where the pairing means generates or receives the spreading key and transmits this key to both the alarm control unit and to each fixed security system.

In some variants, the alarm control unit, comprising the pairing means, is brought close to each fixed security system during the step of bringing it closer 1510.

Once each fixed security system has been paired with the alarm control unit, the alarm control unit is fixed in position in a site at a distance from at least one security system that is greater than the communication range utilized during the transmission step for an emission strength determined.

The communication step 1525 utilizes a means for spread-spectrum communication of the security system and/or of the alarm control unit. During this communication step 1525, a security message is transmitted from the security system to the alarm control unit or vice-versa. This message is, for example, one of five types:
request to send a piece of data representative of the environment near the security system;
request to send a piece of data representative of the state of the security system;
request to activate a function of the security system;
sending a piece of data representative of the environment near the security system;
sending a piece of data representative of the state of the security system. This message also comprises a piece of data representative of the location of the security system.

The supply step 1535 is carried out, for example, by the alarm control unit communicating an alert to a risk prevention service according to a risk detected by a security system. In some variants, this supply step 1535 is carried out, for example, by the alarm control unit emitting a signal towards sound and/or light warning systems present on the site so that these warning systems are activated. In other variants, the supply step 1535 is carried out, for example, by a screen displaying an alarm message and a piece of information representative of the location of the security system.

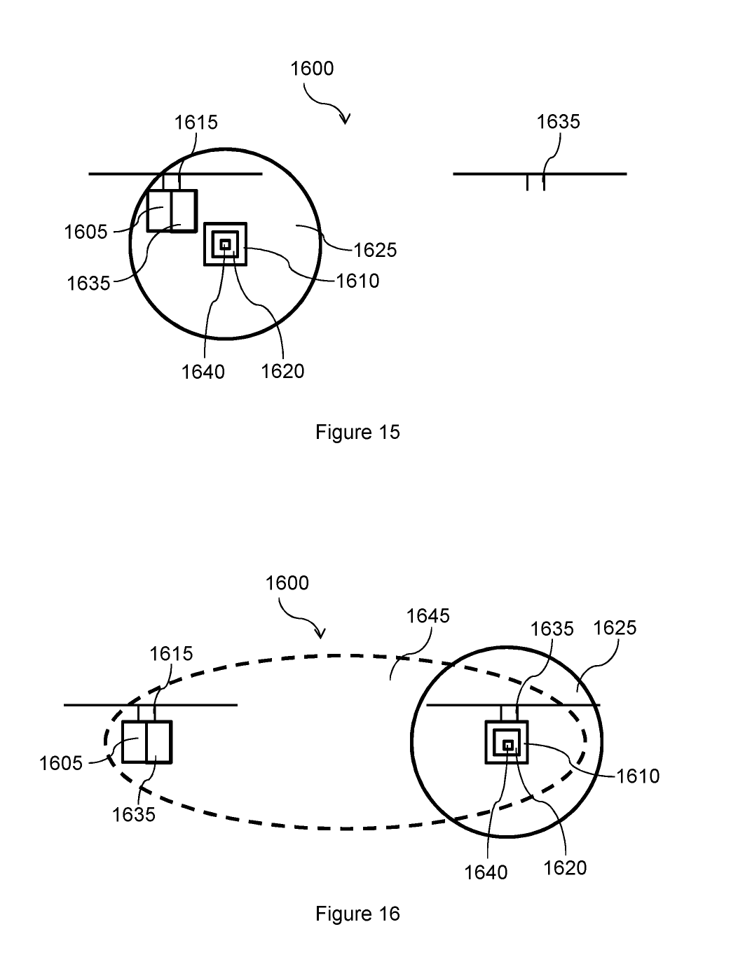

FIG. 15 shows, schematically, a particular embodiment of the device 1600 that is the subject of the present invention. This device 1600 for deploying a link between at least one security system 1605 and an alarm control unit 1610, for implementing the method 1500 described with regard to FIG. 14, comprises:
a means 1615 for fixing each security system 1605;
a mobile pairing means 1620, retaining a frequency-spreading key and comprising a short-range wireless signal transmission means 1640, having a communication range 1625 less than or equal to the communication range of a wireless local network, for transmitting the frequency-spreading key to the security system 1605 via short-range wireless signals;
a means 1630 for fixing the alarm control unit 1610 at a distance from at least one security system 1605 that is greater than the transmission distance of the short-range wireless signal transmission means 1640; and
a means 1635 for communicating a security message between at least one security system 1605 and the alarm control unit 1610, implementing spectrum spreading depending on the spreading key.

Each fixing means 1615 is, for example, a mount fixed to a wall of a site by means of screws, the function of this mount being to accommodate the security system. The fixing means 1615 varies according to the security system 1605 fixed. For example, an autonomous fire detector positioned on a ceiling will utilize, as fixing means 1615, a ceiling mount (not shown). In contrast, an extinguisher will utilize, as fixing means 1615, an extinguisher mount fixed to the wall. The fixing is realized by any known type fixing, in particular screwing, nailing, clamping, magnetizing, for example.

The mobile pairing means 1620 is, for example, a portable terminal communicating with the alarm control unit 1610 having mobility independent of the mobility of the alarm control unit 1610. In some variants, such as the variant represented in FIG. 15, the alarm control unit 1610 is mobile and comprises the mobile pairing means 1620.

The transmission means 1640 is similar to the transmission mode described with regard to FIG. 14. In FIG. 15, the maximum transmission range 1625 for a given emission strength is shown. Outside the area delimited by this range 1625, communication between security system 1605 and mobile pairing means 1620 is impossible or of very poor quality. This range 1625 means that the mobile pairing means 1620 needs to be brought close to each fixed security system 1605 when these systems 1605 are separated by distances that are large in relation to the range 1625 implemented.

When the transmission means 1640 and the security system 1605 are close, the frequency-spreading key or a piece of information representative of this key is transmitted to the security system 1605. Once the alarm control unit 1610 has been fixed at a distance from the security system, this key enables communication with the alarm control unit.

Once the pairing with each security system 1605 has been realized, when the alarm control unit 1610 comprises the mobile pairing means 1620, the alarm control unit 1610 is fixed by the fixing means 1615 in an area of the site to be protected. This fixing means 1615 is of any known type and comprises, for example, a mount for the mobile alarm control unit 1610 fixed to a wall. When the alarm control unit 1610 and the mobile pairing means 1620 are separate, the alarm control unit 1610 can be fixed before or after the pairing of each security system 1605.

The communication means 1635 is, for example, a channel (not shown) for spread-spectrum wireless signals, transmitted between an antenna of the alarm control unit 1610 and of each security system 1605. Spectrum spreading is performed as a function of the frequency-spreading key. In the variant shown in FIG. 15, the communication means 1635 designates an antenna of the security system 1605.

The security system 1605 is, for example:
a sensor, capturing a value representative of a physical magnitude of the sensor environment, communicating a piece of data representative of the value captured, wherein the captured value is representative of the presence of smoke, flames, gas and/or people near the sensor;
an extinguisher mount communicating a piece of data representative of a filling level of an extinguisher fixed to the mount;
an extinguisher communicating a piece of data representative of the presence of an extinguisher fixed to the mount;
a winch, for opening an opening panel in a room, communicating a piece of data representative of the position of the opening panel;
an actuator, for opening an opening panel in a room, communicating a piece of data representative of the position of the opening panel;
a defibrillator mount communicating a piece of data representative of the presence of a defibrillator fixed to the mount;
a liquid leakage detector communicating a piece of data representative of detection of a leakage of liquid;
a sensor, capturing a value representative of a physical magnitude of the sensor environment, communicating a piece of data representative of the value captured;
an extinguisher communicating a piece of data representative of a filling level of the extinguisher;
a defibrillator communicating a piece of data representative of a power charge level of the defibrillator;
a push-button communicating a piece of data representative of a state of the push-button;
an automatic sprinkler system communicating a piece of data representative of a working condition of the sprinkler; and/or
a carbon dioxide distribution means communicating a piece of data representative of a working condition of the distribution means.

In some variants, the security system 1605 comprises an autonomous power supply (not shown), and the security system 1605 communicates a piece of data representative of a charge level of the power supply.

In some variants, the security system 1605 comprises a means (not shown) for emitting an audible and/or visible signal, and wherein the security system 1605 communicates a piece of data representative of a state of the means for emitting an audible and/or visible signal.

FIG. 16 shows the embodiment of the device 1600 described with regard to FIG. 15, wherein the alarm control unit 1610 has been fixed and wherein a communication channel 1645 for spread-spectrum wireless signals between a security system 1605 and the alarm control unit 1610 is shown. It shows, in particular, that the range of this communication channel 1645 is greater than the transmission range 1625 of the transmission means 1640.

1-41. (canceled)

42. Method for deploying a link between at least one security system and an alarm control unit, comprising the steps of:
fixing each security system in a position;
iteratively:
bringing a mobile terminal close to a fixed security system to pair the mobile terminal to the fixed security system, the mobile terminal retaining a frequency-spreading key and comprising a short-range wireless signal transmitter having a transmission range less than or equal to a communication range of a wireless local network;
transmitting the frequency-spreading key to the fixed security system via short-range wireless signals;
fixing the alarm control unit in a position at a distance from said at least one security system that is greater than a transmission distance of the short-range wireless signal transmitter; and
communicating a security message between a communication channel of said at least one security system and the alarm control unit, the communication channel performing a spectrum spreading in accordance with the frequency-spreading key.

43. The method according to claim 42, wherein the alarm control unit is brought close to said each fixed security system to pair the alarm control unit to said each fixed security system.

44. The method according to claim 42, further comprising, iteratively downstream from the transmitting step, the step of recording a data representative of a location of the fixed security system, at least one communication between the fixed security system and the alarm control unit comprises the data representative of the location of the security system.

45. The method according to claim 44, further comprising the step of supplying an alarm signal and a location information for said at least one security system, the alarm signal is emitted in response to a determination that the data received by the alarm control unit is representative of a risk.

46. The method according to claim 42, wherein the short-range wireless signals are transmitted using the Bluetooth standard.

47. The method according to claim 42, wherein the frequency-spreading key is transmitted via a signal emitted depending on a frequency of a spread-spectrum wireless signal.

48. The method according to claim 42, further comprising, iteratively downstream from the bringing step, the steps of:
detecting a pairing signal as a function of a strength of a signal received according to an operating frequency of the communications channel higher than a limit value; and
receiving the frequency-spreading key by the communication channel in response to a detection of the pairing signal.

49. The method for protecting a site by deploying a link according to claim 42, comprising the steps:
fixing a mount to a wall, the mount comprising a removable fastener for a portable communicating alarm control unit;
wirelessly transmitting by a portable communicating alarm control unit to communicate with at least one sensor;
short-range wireless pairing of the portable communicating alarm control unit with said at least one sensor;
capturing at least one value representative of a physical magnitude by a fixed sensor and emitting at least one piece of data representative of said one value captured or receiving a wireless signal via a spread-spectrum wireless transmission; and
transmitting a piece of data representative of a detection of an anomaly in response to a determination that said at least one value captured is greater than a predefined limit value.

50. The method according to claim 49, further comprising, upstream from the short-range wireless pairing step, the step of fixing said at least one sensor to the wall of the site.

51. The method according to claim 49, further comprising the steps of storing a path passing through said at least one sensor; and displaying the stored path.

52. A device implementing the method according to claim 42 to deploy the link between said at least one security system and the alarm control unit, comprising:
a first mount to fix said each security system;
the mobile terminal retains the frequency-spreading key and comprises the short-range wireless signal transmitter having a transmission range less than or equal to the communication range of the wireless local network, the mobile terminal is paired to said each security system and transmits the frequency-spreading key to said each security system via the short-range wireless signals;
a second mount to fix the alarm control unit at the distance from said at least one security system that is greater than the transmission distance of the short-range wireless signal transmitter; and
the communication channel to communicate a security message between said at least one security system and the alarm control unit, the communication channel performing a spectrum spreading in accordance with the frequency-spreading key.

53. The device according to claim 52, wherein said at least one security system is a sensor, the sensor captures a value representative of a physical magnitude of a sensor environment and communicates a piece of data representative of the value captured.

54. A device implementing the method according to claim 42 to protect a site, comprising:
a mount, configured to be fixed to a wall, the mount comprising a removable fastener to support a portable communicating alarm control unit;
at least one fixed sensor to capture a value representative of a physical magnitude, and comprising a spread-spectrum wireless transmitter/receiver configured to emit at least one piece of data representative of the value captured or to receive a wireless signal;
wherein the portable communicating alarm control unit comprises:
a spread-spectrum wireless transmitter/receiver to communicate with said at least one fixed sensor;
a short-range wireless pairing unit to pair the portable communicating alarm control unit with said at least one fixed sensor utilizing the spread-spectrum wireless transmitter/receiver; and
a detector configured to transmit a piece of data representative of a detection of an anomaly in response to a determination that said at least one value captured is greater than a predefined limit value.

55. The device according to claim 54, wherein the portable communicating alarm control unit comprises:
a selector to select a signal, emitted by said at least one fixed sensor, having a strongest reception by the portable communicating alarm control unit; and
a trigger to initiate pairing of the portable communicating alarm control unit with a sensor associated with the selected signal by the short-range wireless pairing unit.

56. The device according to claim 55, wherein said at least one fixed sensor comprises a short-range wireless pairing unit to pair with the portable communicating alarm control unit, the short-range wireless pairing unit is configured to wireless transmit a pairing request signal until said at least one fixed sensor is paired with the portable communicating alarm control unit; and wherein the short-range wireless pairing unit of the portable communicating alarm control unit comprises an electronic circuit to measure a reception strength of the pairing request signal emitted by the short-range wireless pairing unit of said at least one fixed sensor, the short-range wireless pairing unit of the portable communicating alarm control unit is configured to pair the portable communicating alarm control unit and said at least one fixed sensor in response to a determination that the reception strength of the emitted pairing request signal is greater than a predefined limit value.

57. The device according to claim 56, wherein the selector selects a first received signal emitted by the short-range wireless pairing unit of a first sensor with a strongest reception strength and a second received signal emitted by the short-range wireless pairing unit of a second sensor with a second strongest reception strength; wherein the electronic circuit to measure the reception strength of the signal performs a comparison between the two reception strengths of the first and second selected signals; and the short-range wireless pairing unit of the portable communicating alarm control unit pairs the portable communicating alarm control unit with the sensor emitting the signal having the greatest strength in response to a determination that said comparison is greater than a predefined limit value.

58. The device according to claim 54, wherein at least one element among at least one of the portable communicating alarm control unit said at least one fixed sensor comprises a verifier to verify a working condition of each element and a transmitter to transmit a piece of data representative of the working condition.

59. The device according to claim 54, wherein the portable communicating alarm control unit comprises a storage unit to store a path passing through said at least one sensor; and a screen to display the stored path.

60. The device according to claim 54, wherein the mount comprises a locking element to lock the removable fastener, and a power supply to supply power to a battery of the portable communicating alarm control unit.
